(19) United States
(12) Patent Application Publication
(10) Pub. No.: US 2021/0049303 A1
(43) Pub. Date: Feb. 18, 2021

(54) INFORMATION PROCESSING APPARATUS AND INFORMATION PROCESSING METHOD, AND PROGRAM

(71) Applicant: SONY CORPORATION, TOKYO (JP)

(72) Inventors: TAKEHIKO MORITA, KANAGAWA (JP); MITSURU TAKEHARA, TOKYO (JP); SHINYA MARUYAMA, KANAGAWA (JP)

(21) Appl. No.: 16/964,587

(22) PCT Filed: Jan. 24, 2019
(86) PCT No.: PCT/JP2019/002157

§ 371 Date: Jul. 23, 2020

(30) Foreign Application Priority Data
Feb. 7, 2018 (JP) 2018-020160

(51) Int. Cl. G06F 21/62; G06F 40/20

(52) U.S. Cl. CPC G06F 21/6263; G06F 40/20

(57) ABSTRACT

The present disclosure relates to an information processing apparatus and an information processing method that can assist understanding and consent for a personal information protection policy such as a privacy policy, and a program. A privacy policy is analyzed for every item, difference information including a common item and a difference item is generated, and a summary is generated and displayed on the basis of the difference information. It is possible to apply to privacy policy management.

### TECHNICAL FIELD

The present disclosure relates to an information processing apparatus and an information processing method, and a program, and particularly to an information processing apparatus and an information processing method capable of assisting understanding and consent by analyzing information regarding consent to use personal information such as a privacy policy, and presenting a main point to a user in an easily recognizable manner, and a program.

### BACKGROUND ART

In using services provided on the Internet, a privacy policy may be presented, and consent for provision of personal information may be required.

Through a utilization of personal information of users related to service provision, by a provider of services on the Internet, improvement of quality of the services and creation of business opportunities are expected.

Therefore, there has been a case of presenting a personal information protection policy as represented by a privacy policy, and asking a user for consent regarding use of personal information, to provide services to a user who has accepted the consent, or to provide the services to all the users but use personal information of only a user who has accepted the consent to use personal information.

Regarding the use of such personal information, there has been proposed a technique for controlling access to a service, for example, by acquiring a privacy policy document associated with the service, performing natural language analysis, and referring to an item defined in an access control policy set in advance by a user from a result of the natural language analysis (see Patent Document 1).

### CITATION LIST

### Patent Document

### Patent Document 1: Japanese Patent Application Laid-Open No. 2014-115869

### SUMMARY OF THE INVENTION

### Problems to be Solved by the Invention

However, in the technique according to Patent Document 1, since the user is required to set an access control policy in advance that includes many difficult items, and also required to understand and then set each item, complicated and laborious work has been necessary.

The present disclosure has been made in view of such circumstances, and an object thereof is to assist understanding and consent for a personal information protection policy, in particular, by analyzing information regarding consent for a personal information protection policy such as a privacy policy and presenting a main point to a user in an easily recognizable manner.

### Solutions to Problems

An information processing apparatus according to one aspect of the present disclosure is an information processing apparatus including: an analysis unit configured to analyze an item of a service agreement; and a summary generation unit configured to generate a summary of a service agreement on the basis of an analysis result by the analysis unit.

It is possible to further include: a service agreement item analysis unit configured to analyze an item of the service agreement, list a content for every item, and generate a service agreement item group for every the service agreement; and a service agreement item management unit that stores and manages the service agreement item group that is for every the service agreement and is generated by the service agreement item analysis unit.

The analysis unit can be made to generate, as an analysis result, difference information including a common item and a difference item in a same item of a plurality of service agreements.

The summary generation unit can be made to generate the summary for emphasis display of a difference item in the difference information, on the basis of an analysis result including the difference information.

It is possible to further include a summary description generation unit configured to generate a summary description on the basis of an analysis result including the difference information, and the summary generation unit can be made to process and generate the summary description in accordance with a terminal device operated by a user to whom the summary is presented.

In a case where the terminal device has a display unit smaller than a first area, the summary generation unit can be made to generate a summary by processing the summary description into a simple list, supply in response to a request from the terminal device, and cause the display unit to display.

It is possible to further include a detailed information generation unit, in which, in a case where the summary is obtained by processing the summary description into a simple list, when an item processed into the simple list is selected, the detailed information generation unit generates detailed information of the selected item, supplies in response to a request from the terminal device, and causes display.

In a case where the terminal device has a display unit smaller than a second area that is further smaller than the first area, the summary generation unit can be made to iconify the summary description to generate a summary.

In a case where the terminal device has a voice output unit configured to output voice, the summary generation unit can be made to generate a summary by processing the summary description into voice data.

The summary generation unit can be made to generate a summary by processing, into voice data, the summary description for emphasis of a difference item in the difference information by voice, on the basis of an analysis result including the difference information.

It is possible to further include a service agreement item analysis unit configured to analyze an item of the service agreement, list a content for every item, and generate a service agreement item group for every the service agreement. In a case where the terminal device has a display unit larger than a predetermined area, the summary generation unit can be made to use information of the service agreement item group as it is and generate a summary for emphasis display of information of the difference item.

It is possible to further include: a consent/refusal management unit configured to accept and manage consent or refusal of a user for the service agreement; a reason ascertainment unit configured to ascertain a reason for the consent or refusal; and a weighting unit configured to weight every item in the service agreement item group in accordance with a reason ascertained by the reason ascertainment unit. The summary generation unit can be made to adjust emphasis display for the every item to generate a summary, in accordance with a weight weighted by the weighting unit.

It is possible to further include: a gender estimation unit configured to estimate gender on the basis of voice uttered by the user; and an age estimation unit configured to estimate age on the basis of voice uttered by the user. The summary generation unit can be made to adjust emphasis display for the every item to generate a summary, on the basis of a weight weighted by the weighting unit, gender estimated by the gender estimation unit, and age estimated by the age estimation unit.

It is possible to further include a text conversion unit configured to convert a service agreement that is printed or displayed, into text from an image obtained by imaging a service agreement that is printed or displayed. The analysis unit can be made to analyze an item of the service agreement converted into the text, and the summary generation unit can be made to generate a summary for emphasis display, by overlaying and displaying on the imaged service agreement that is printed or displayed on the image for the every item, in accordance with a weight weighted by the weighting unit.

The consent/refusal management unit can be made to, when accepting consent or refusal of a user for the service agreement, preform conversion into a format receivable by each service providing device that provides a service corresponding to the service agreement, and notify of information about the consent or refusal.

It is possible to further include a voiceprint extraction unit configured to extract a voiceprint on the basis of voice uttered by the user, and the consent/refusal management unit can be made to, when accepting consent or refusal of a user for the service agreement, store the voiceprint in a predetermined storage unit in association with information about the consent or refusal.

The service agreement item analysis unit can be made to analyze an item, list a content for every item, and generate a service agreement item group for every the service agreement in accordance with a language describing the service agreement.

The language describing the service agreement can be made to include a natural language, JavaScript object notation (JSON)/extensible markup language (XML), and a hypertext markup language (HTML).

An information processing method according to one aspect of the present disclosure is an information processing method including: an analyzing process of analyzing an item of a service agreement; and a summary generating process of generating a summary of a service agreement on the basis of an analysis result by the analyzing process.

A program of one aspect of the present disclosure is a program for causing a computer to function as: an analysis unit configured to analyze an item of a service agreement; and a summary generation unit configured to generate a summary of a service agreement on the basis of an analysis result by the analysis unit.

In one aspect of the present disclosure, an item of a service agreement is analyzed, and a summary of the service agreement is generated on the basis of an analysis result.

### Effects of the Invention

According to one aspect of the present disclosure, it is possible to particularly assist understanding and consent for a personal information protection policy such as a privacy policy.

### BRIEF DESCRIPTION OF DRAWINGS

FIG. 1 is a diagram illustrating a configuration example of a privacy policy agent system according to the present disclosure.

FIG. 2 is a block diagram for explaining a configuration example of a privacy policy agent device according to a first embodiment of the present disclosure.

FIG. 3 is a block diagram for explaining a configuration example of a policy item analysis unit of FIG. 2.

FIG. 4 is a view for explaining item analysis information analyzed by the policy item analysis unit of FIG. 3.

FIG. 5 is a block diagram for explaining a configuration example of a policy item management unit of FIG. 2.

FIG. 6 is a view for explaining a configuration example of a policy item group.

FIG. 7 is a block diagram for explaining a configuration example of a policy analysis unit of FIG. 2.

FIG. 8 is a view for explaining difference information as an analysis result of the policy analysis unit in FIG. 7.

FIG. 9 is a block diagram for explaining a configuration example of a summary generation unit of FIG. 2.

FIG. 10 is a block diagram for explaining a configuration example of an instruction analysis unit of FIG. 2.

FIG. 11 is a block diagram for explaining a configuration example of a policy detail acquisition unit of FIG. 2.

FIG. 12 is a block diagram for explaining a configuration example of a consent/refusal management unit of FIG. 2.

FIG. 13 is a flowchart for explaining a policy item analyzing process performed by the privacy policy agent device of FIG. 2.

FIG. 14 is a flowchart for explaining a privacy policy agent process by the privacy policy agent device of FIG. 2.

FIG. 15 is a flowchart for explaining a policy item searching process by the privacy policy agent device of FIG. 2.

FIG. 16 is a flowchart for explaining a policy analyzing process by the privacy policy agent device of FIG. 2.

FIG. 17 is a view for explaining the policy analyzing process by the privacy policy agent device of FIG. 2.

FIG. 18 is a view for explaining the policy analyzing process by the privacy policy agent device of FIG. 2.

FIG. 19 is a view for explaining the policy analyzing process by the privacy policy agent device of FIG. 2.

FIG. 20 is a view for explaining a policy item group obtained by the policy item analyzing process.

FIG. 21 is a flowchart for explaining a summary generating process by the privacy policy agent device of FIG. 2.

FIG. 22 is a view for explaining a display example of a summary generated by the summary generating process by the privacy policy agent device of FIG. 2.

FIG. 23 is a flowchart for explaining a policy detail displaying process by the privacy policy agent device of FIG. 2.

FIG. 24 is a flowchart for explaining a consent/refusal managing process by the privacy policy agent device of FIG. 2.

FIG. 25 is a view for explaining an example of presentation of a summary by voice by the privacy policy agent device of FIG. 2.

FIG. 26 is a block diagram for explaining a configuration example of a privacy policy agent device according to a second embodiment of the present disclosure.

FIG. 27 is a block diagram for explaining a configuration example of an instruction analysis unit of FIG. 26.

FIG. 28 is a block diagram for explaining a configuration example of a summary generation unit of FIG. 26.

FIG. 29 is a flowchart for explaining an item weighting process by the privacy policy agent device of FIG. 26.

FIG. 30 is a flowchart for explaining a privacy policy agent process by the privacy policy agent device of FIG. 26.

FIG. 31 is a flowchart for explaining a summary generating process by the privacy policy agent device of FIG. 26.

FIG. 32 is a view for explaining a display example of a summary generated by the summary generating process by the privacy policy agent device of FIG. 26.

FIG. 33 is a block diagram for explaining a configuration example of a privacy policy agent device according to a third embodiment of the present disclosure.

FIG. 34 is a flowchart for explaining a privacy policy agent process by the privacy policy agent device of FIG. 33.

FIG. 35 is a flowchart for explaining a consent/denial automatic determination process by the privacy policy agent device of FIG. 26.

FIG. 36 is a diagram for explaining a configuration example of a general-purpose computer.

### MODE FOR CARRYING OUT THE INVENTION

Hereinafter, a preferred embodiment of the present disclosure will be described in detail with reference to the accompanying drawings. Note that, in this specification and the drawings, components having substantially the same functional configuration are denoted by the same reference numerals, and redundant descriptions are omitted.

Hereinafter, embodiments for implementing the present technology will be described. Note that the description will be given in the following order.

1. Outline of present disclosure

2. First embodiment

3. Second embodiment

4. Third embodiment

5. Example of execution by software

### 1. Outline of Present Disclosure

The technology of the present disclosure is to present a main point of a privacy policy that is a personal information protection policy related to service provision in an easily recognizable format and assist consent, when a user uses a terminal to receive the service provision from various service devices provided on a network represented by the Internet. Note that the privacy policy in this example is a generic term for agreements and contracts regarding consent to use personal information, and is not necessarily what is called a privacy policy as long as it is related. That is, the privacy policy in this example includes the whole related to terms of use and contracts regarding consent to use personal information, and includes, for example, what is called a privacy agreement, a service agreement, and the like.

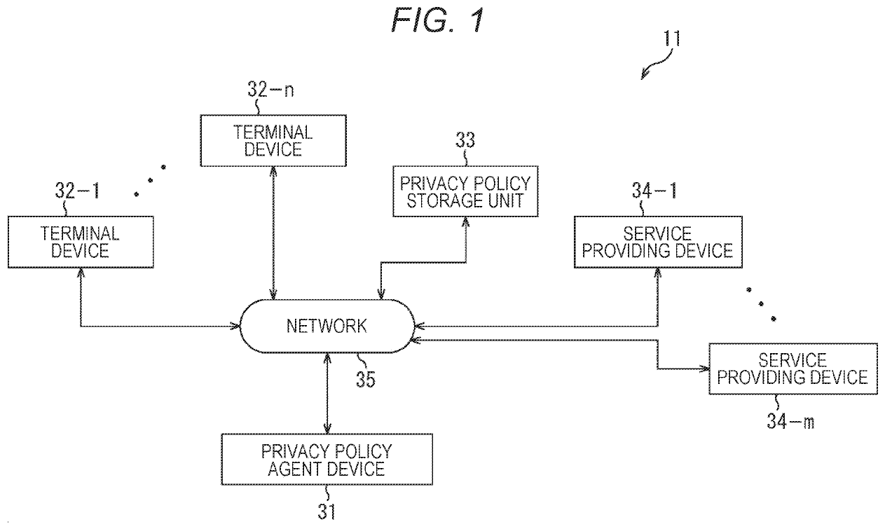

More specifically, the functions described above are realized by, for example, a privacy policy agent system as shown in FIG. 1.

A privacy policy agent system 11 in FIG. 1 includes: a privacy policy agent device 31, terminal devices 32-1 to 32-n, a privacy policy storage unit 33, service providing devices 34-1 to 34-m, and a network 35. Note that, in a case where it is not particularly necessary to distinguish each of the terminal devices 32-1 to 32-n and the service providing devices 34-1 to 34-m, they are simply referred to as a terminal device 32 and a service providing device 34, and other configurations are also referred to in a similar manner.

When the terminal devices 32-1 to 32-n owned by a user are operated, the privacy policy agent device 31 access a corresponding service providing device 34 via the network 35 represented by the Internet. Then, in receiving service provision, the privacy policy agent device 31 reads out a privacy policy corresponding to the service to be provided, from the privacy policy storage unit 33 that stores the privacy policy read from the service providing device 34 in advance. Moreover, the privacy policy agent device 31 analyzes the read privacy policy, generates a summary easily recognizable by the user, and causes the terminal device 32 to perform presentation. With such a series of processes, the privacy policy agent device 31 assists checking and consent for the privacy policy.

### 2. First Embodiment

<Configuration Example of Privacy Policy Agent Device and Terminal Device>

Next, a configuration example of the privacy policy agent device 31 and the terminal device 32 included in the privacy policy agent system 11 of FIG. 1 will be described.

The privacy policy agent device 31 includes: a policy item analysis unit 51, a policy item management unit 52, a policy analysis unit 53, a summary generation unit 54, a dialog recording unit 55, a dialog history storage unit 56, an instruction analysis unit 57, a policy detail acquisition unit 58, a consent/refusal management unit 59, and a consent/refusal history storage unit 60.

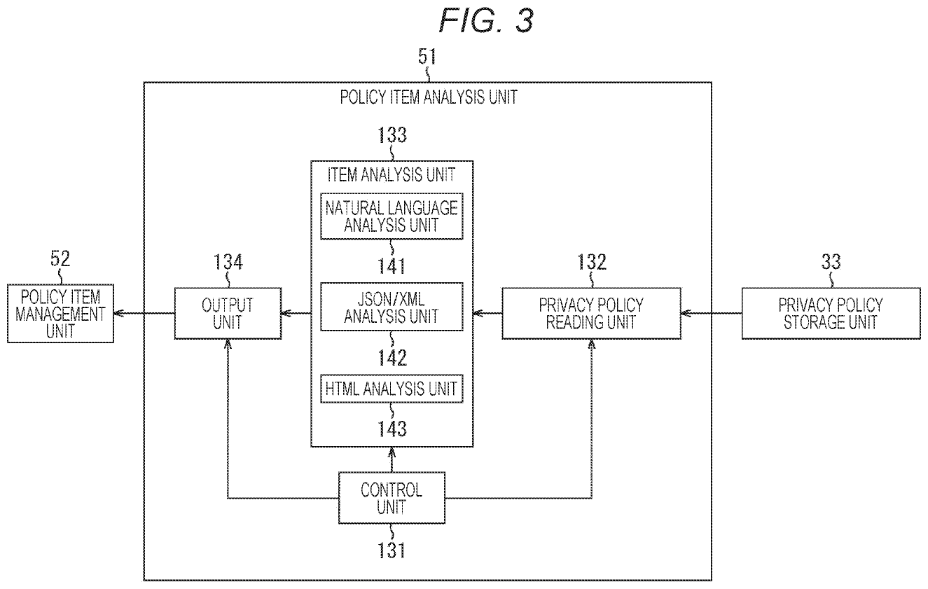

The policy item analysis unit 51 reads out privacy policies 91-1 to 91-n stored in advance in the privacy policy storage unit 33 for every type of a service to be provided by the service providing device 34 to analyze items, and stores an analysis result in the policy item management unit 52 as policy item groups 71-1 to 71-n for every service. Note that a detailed configuration example of the policy item analysis unit 51 will be described later in detail with reference to a block diagram of FIG. 3.

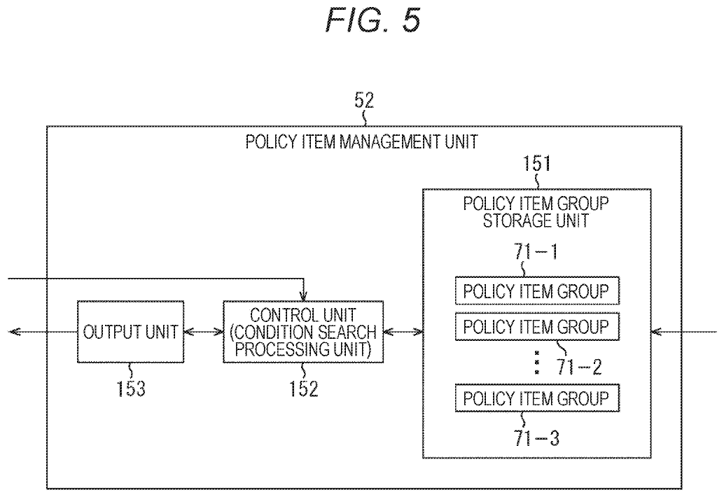

The policy item management unit 52 stores the policy item group 71 that is for every service and is an item analysis result of the policy item analysis unit 51, and reads out the policy item group 71 of the corresponding service and the policy item group 71 of a related service in the past, to supply to the policy analysis unit 53 when the terminal device 32 is operated to receive predetermined service provision. Note that a detailed configuration example of the policy item management unit 52 will be described later in detail with reference to a block diagram of FIG. 5.

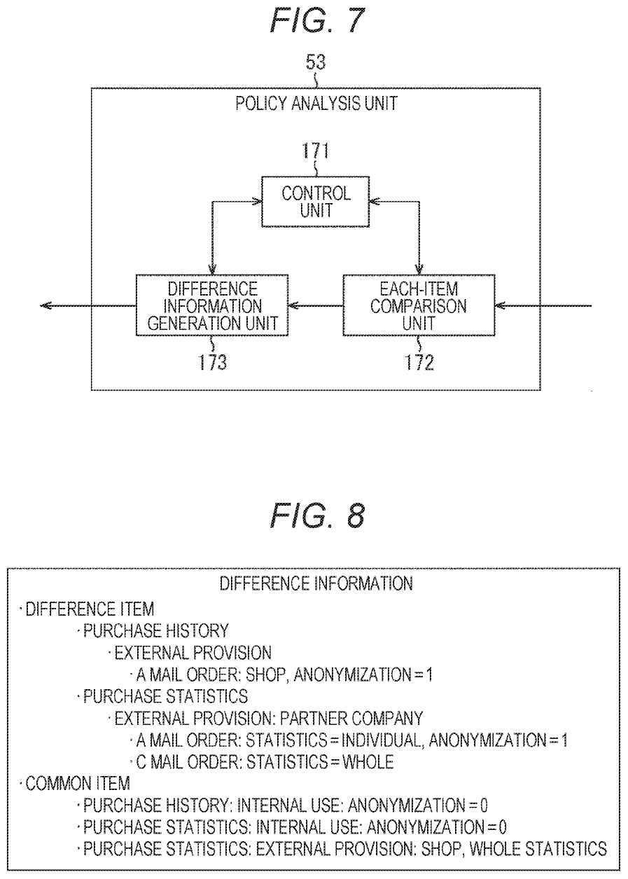

The policy analysis unit 53 analyzes the policy item group 71 supplied from the policy item management unit 52 in units of items, obtains, for example, difference information from a common item that is common to every item and a difference item different for every item, and outputs to the summary generation unit 54 as an analysis result. Note that a detailed configuration example of the policy analysis unit 53 will be described later in detail with reference to a block diagram of FIG. 7.

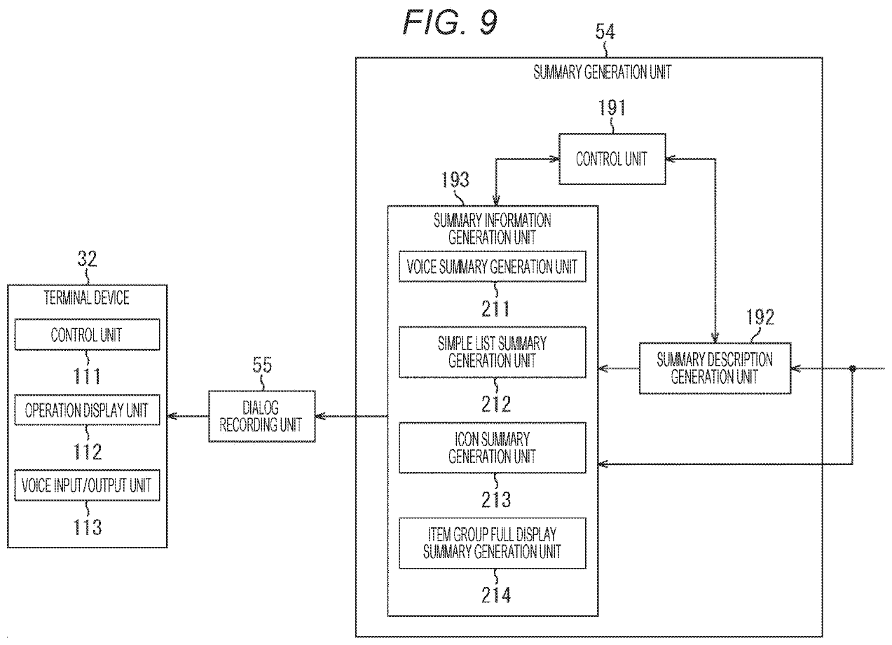

The summary generation unit 54 generates a summary of a privacy policy in a format easily recognizable by the user in the terminal device 32, on the basis of the difference information that is the policy analysis result supplied from the policy analysis unit 53, and transmits to the terminal device 32 via the dialog recording unit 55. Note that a detailed configuration of the summary generation unit 54 will be described later in detail with reference to a block diagram of FIG. 9.

The dialog recording unit 55 stores, in the dialog history storage unit 56, as a dialog history, dialog data including voice, text data, and the like exchanged between the privacy policy agent device 31 and the terminal device 32, such as a summary transmitted to the terminal device 32, policy details, and various commands transmitted from the terminal device 32.

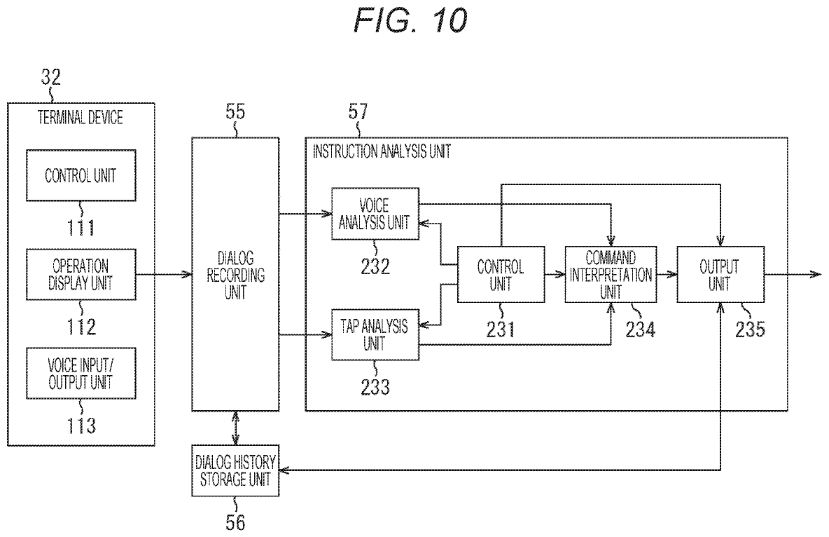

The instruction analysis unit 57 analyzes an instruction content supplied from the terminal device 32 via the dialog recording unit 55, and supplies to the policy detail acquisition unit 58 in a case of a command requesting display of detailed information for a summary of a privacy policy. Furthermore, in a case of an instruction command regarding consent or refusal, the instruction analysis unit 57 supplies the consent/refusal management unit 59 with the instruction command regarding consent or refusal. Note that a detailed configuration example of the instruction analysis unit 57 will be described later in detail with reference to a block diagram of FIG. 10.

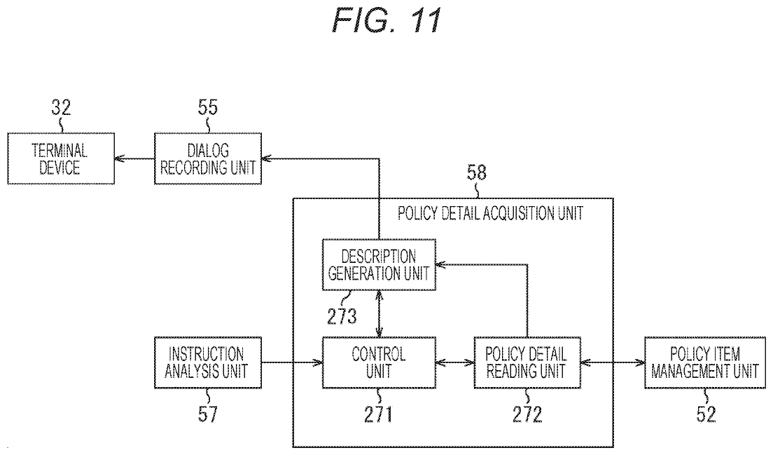

The policy detail acquisition unit 58 accesses the policy item management unit 52 when a command requesting display of detailed information of a privacy policy from the terminal device 32 is supplied from the instruction analysis unit 57, acquires more detailed information of the policy item group 71 of the corresponding privacy policy among the stored policy item groups 71, and transmits to the terminal device 32 via the dialog recording unit 55. Note that a configuration example of the policy detail acquisition unit 58 will be described later in detail with reference to a block diagram of FIG. 11.

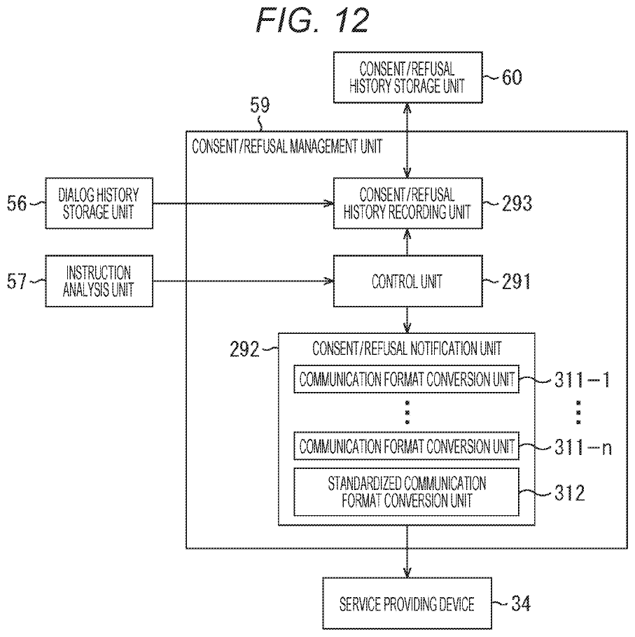

The consent/refusal management unit 59 performs, when a command regarding consent or refusal is supplied from the instruction analysis unit 57, conversion into a signal of a communication format recognizable in each service providing device 34, and notifies of a response regarding consent or refusal for the privacy policy. Furthermore, when a command regarding consent or refusal is supplied, the consent/refusal management unit 59 causes the consent/refusal history storage unit 60 to store the command regarding consent or refusal in association with a dialog at the timing of being stored in the dialog history storage unit 56. Note that a configuration example of the consent/refusal management unit 59 will be described later in detail with reference to a block diagram of FIG. 12.

The terminal device 32 is, for example, a smartphone, a portable tablet, or the like, and is used at a time of receiving predetermined service provision from the service providing device 34 via the Internet. More specifically, when receiving predetermined service provision, the terminal device 32 receives and presents a summary of a privacy policy related to a service to be received as the service provision from the privacy policy agent device 31 in accordance with an operation content of the user. With such an operation, the terminal device 32 assists recognition and consent and refusal of the privacy policy.

The terminal device 32 includes a control unit 111, an operation display unit 112, and a voice input/output unit 113.

The control unit 111 includes a processor, a memory, and the like, and controls the entire operation of the terminal device 32.

The operation display unit 112 is a so-called touch panel, and the operation display unit 112 is controlled by the control unit 111 to display various kinds of information as an image, and accepts an operation input by a user's touch to generate a corresponding operation signal.

The voice input/output unit 113 has a configuration in which a microphone and a speaker are integrated, and the voice input/output unit 113 is controlled by the control unit 111 to output various kinds of service provision as voice, and accepts an operation by user's utterance to generate a corresponding operation signal.

<Configuration Example of Policy Item Analysis Unit>

Next, a configuration example of the policy item analysis unit 51 will be described with reference to the block diagram of FIG. 3.

The policy item analysis unit 51 includes a control unit 131, a privacy policy reading unit 132, an item analysis unit 133, and an output unit 134.

The control unit 131 includes a processor and a memory, and controls the entire operation of the policy item analysis unit 51.

The privacy policy reading unit 132 is controlled by the control unit 131 to sequentially read out the privacy policies 91-1 to 91-n stored in advance in the privacy policy storage unit 33 and corresponding to each service provided by the service providing device 34-1, and output to the item analysis unit 133.

The item analysis unit 133 includes an analysis unit that supports multiple languages, and includes a natural language analysis unit 141, a JavaScript object notation (JSON)/extensible markup language (XML) analysis unit 142, and an a hypertext markup language (HTML) analysis unit 143.

That is, in accordance with a language used to describe the privacy policy read by the privacy policy reading unit 132, the natural language analysis unit 141 is used in a case where description is in natural language, the JSON/XML analysis unit 142 is used in a case where description is in JSON/XML, and the HTML analysis unit 143 is used in a case where description is in HTML, and the privacy policy is analyzed for every item and outputted to the output unit 134.

The output unit 134 causes a policy item analysis result to be outputted to the policy item management unit 52 and stored as the policy item groups 71-1 to 71-n.

<Policy Item Analysis Information>

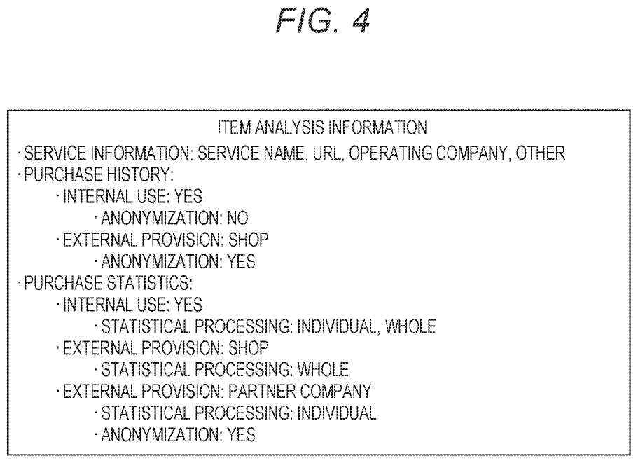

Here, with reference to FIG. 4, a description is given to an example of privacy policy item analysis information analyzed by the item analysis unit 133 including the natural language analysis unit 141, the JSON/XML analysis unit 142, and the HTML analysis unit 143.

A privacy policy includes, for example, items such as service information, a purchase history, and purchase statistics.

The service information is, for example, information such as a service name, a uniform resource locator (URL), and an operating company (a company that provides a service with the service providing device 34).

Furthermore, the purchase history is, for example, information indicating a history when a certain product is purchased by a user at a time of using a service.

Furthermore, for the purchase history, there are two types of information to be used internally and information to be provided externally. The information to be used internally is information to be used inside the service providing operating company, and the presence or absence of information to be used internally is registered as an item.

Furthermore, the information to be provided externally is information to be provided, as a purchase history when the service is used, from the service providing operating company to an external company (shop operator) to be used, and the presence or absence of externally provided information is registered as an item.

In FIG. 4, “shop” is registered as the external provision information, which indicates utilization by a shop operator that does not directly manage the service provision but is external to a company that manages the service provision.

Moreover, for each of the internal use information and the external use information in the purchase history, there is information about whether or not anonymization is performed, and it is set whether the information is anonymized to be used or is used without anonymization, at a time of being used.

Furthermore, the purchase statistics are, for example, information indicating whether or not a purchase history when the service is used is to be used as statistics.

Also for the purchase statistics, there are information to be used internally and information to be provided externally. The information to be used internally is information indicating whether or not to be used as statistical information inside the service providing operating company.

Furthermore, the information to be provided externally is information indicating whether or not to be provided from the service providing operating company to an external company as purchase statistics when the service is used, and used as statistical information.

FIG. 4 shows that there is information to be used internally as purchase statistics, and that statistical processing is performed for an individual and the whole. Furthermore, it is shown that information to be provided externally is provided externally to a shop operator and a partner company, and the statistical processing is for the whole for the shop operator, while statistical processing is for an individual and is anonymized to be used for the partner company.

That is, also for the information to be used for purchase statistics, it is possible to select whether or not to be anonymized as an item.

<Configuration Example of Policy Item Management Unit>

Next, a configuration example of the policy item management unit 52 will be described with reference to the block diagram of FIG. 5.

The policy item management unit 52 includes a policy item group storage unit 151, a control unit (condition search processing unit) 152, and an output unit 153.

The control unit (condition search processing unit) 152 includes a processor, a memory, and the like, and controls the entire operation of the policy item management unit 52.

Furthermore, via the dialog recording unit 55, from the policy item group storage unit 151 that stores the policy item group 71, the control unit 152 searches for and reads out a corresponding policy item group 71 in accordance with a type of service provision from a command from the terminal device 32, and outputs from the output unit 153 to the summary generation unit 54.

<Configuration Example of Policy Item Group>

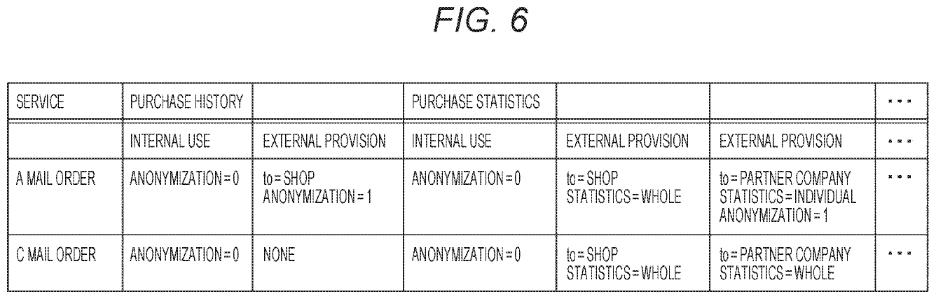

Here, a configuration example of the policy item group 71 will be described with reference to FIG. 6.

The policy item group 71 is formed as the policy item group 71-1, 71-2, 71-3, . . . in the policy item group storage unit 151 in units shown in each column in a vertical direction in FIG. 6.

In FIG. 6, two types of policy item groups 71 are formed, and each one column forms the policy item group 71 from the top.

FIG. 6 shows a configuration of each of the policy item groups 71 in which the service is A mail order and C mail order from the top, and shows a purchase history and purchase statistics from left to right in the figure.

Then, the purchase history is shown to be used internally in a non-anonymous (anonymization=0) state in the A mail order, and is shown to be provided externally to a shop operator in an anonymous (anonymization=1) state.

Furthermore, the purchase history is shown to be used internally in a non-anonymous (anonymous=0) state in the C mail order, and to have no information to be provided externally.

Moreover, in both the A mail order and the C mail order, the purchase statistics are shown to be used internally in a non-anonymous (anonymization=0) state, and shown to be provided externally as whole statistics to the shop operator.

Moreover, other purchase statistics are shown to be anonymized to be provided externally to a partner company as statistics of an individual (statistics=individual) in the A mail order, and shown to be provided externally to a partner company as overall statistics in the C mail order.

<Configuration Example of Policy Analysis Unit>

Next, a detailed configuration example of the policy analysis unit 53 will be described with reference to the block diagram of FIG. 7.

The policy analysis unit 53 includes a control unit 171, an each-item comparison unit 172, and a difference information generation unit 173.

The control unit 171 includes a processor, a memory, and the like, and controls the entire operation of the policy analysis unit 53.

The each-item comparison unit 172 compares contents of the same items in the policy item group 71 supplied from the policy item management unit 52, generates information of a common item and information of a difference item, and outputs to the difference information generation unit 173.

The difference information generation unit 173 generates difference information on the basis of the information of the common item and information of the difference item, which are a comparison result of the policy item group 71, and outputs to the summary generation unit 54 as an analysis result by the policy analysis unit 53.

<Configuration Example of Difference Information>

Here, a configuration example of difference information will be described with reference to FIG. 8. The difference information of FIG. 8 is difference information in a case of the respective policy item groups 71 of the A mail order and the C mail order of FIG. 6.

The difference information includes, for example, an information field of a difference item as shown in an upper part of FIG. 8, and an information field of common item in a lower part.

The information field of the difference item further includes an information field of a purchase history and an information field of purchase statistics.

As shown in FIG. 8, in information of the difference item, in the policy item group 71 managed by the policy item management unit 52 in FIG. 6, information to be provided externally in the purchase history and the information to be provided externally in the purchase statistics are individually different for the A mail order and the C mail order.

That is, in the purchase history information, information of the difference item is that provision is made with anonymization to a shop operator for the A mail order as the service, but there is no information provided for the C mail order.

Furthermore, regarding the A mail order as the service, the purchase statistics information is anonymized to be provided to a partner company as information for obtaining individual statistics. However for the C mail order, the purchase statistics information is provided without anonymization to a partner company as information for obtaining overall statistics.

Moreover, as shown in FIG. 8, regarding information of a common item between the A mail order and the C mail order as the service, the purchase history information is used internally without anonymization, and the purchase statistics information is used internally without anonymization and provided without anonymization to a shop side as information for obtaining overall purchase statistics.

As described above, the difference information includes the difference items and the common items in each of the purchase history and the purchase statistics, which are items in the policy item group 71 to be compared.

<Configuration Example of Summary Generation Unit>

Next, a configuration example of the summary generation unit 54 will be described with reference to the block diagram of FIG. 9.

The summary generation unit 54 includes a control unit 191, a summary description generation unit 192, and a summary information generation unit 193.

The control unit 191 includes a processor and a memory, and controls the entire operation of the summary generation unit 54.

The summary description generation unit 192 forms a sentence explaining difference information on the basis of the difference information, generates a summary description, and outputs to the summary information generation unit 193.

On the basis of the summary description, the summary information generation unit 193 processes and generates information into a format that can be presented in the terminal device 32, and outputs to the terminal device 32 via the dialog recording unit 55.

More specifically, the summary information generation unit 193 includes a voice summary generation unit 211, a simple list summary generation unit 212, an icon summary generation unit 213, and an item group full display summary generation unit 214.

The voice summary generation unit 211 generates, on the basis of summary description information, summary information including a voice summary such as for reading the summary description by voice, and outputs the generated summary information including the voice summary to the terminal device 32 via the dialog recording unit 55.

On the basis of summary description information, the simple list summary generation unit 212 generates a simple list summary that can be displayed on a relatively small operation display unit 112 such as a smartphone, and outputs summary information including the generated simple list summary to the terminal device 32 via the dialog recording unit 55.

The icon summary generation unit 213 generates, on the basis of summary description information, summary information including an icon summary that can be displayed on a small operation display unit 112 even smaller than a smartphone, for example, such as a smart watch, and outputs the generated icon summary information to the terminal device 32 via the dialog recording unit 55.

The item group full display summary generation unit 214 generates, without using a summary description, a full display summary including a list of information for each item in difference information and being able to be displayed on the operation display unit 112, such as a tablet, provided with a display having a relatively large display area, and outputs information of the generated full display summary to the terminal device 32 via the dialog recording unit 55.

<Configuration Example of Instruction Analysis Unit>

The instruction analysis unit 57 includes a control unit 231, a voice analysis unit 232, a tap analysis unit 233, a command interpretation unit 234, and an output unit 235.

The control unit 231 includes a processor, a memory, and the like, and controls the entire operation of the instruction analysis unit 57.

The voice analysis unit 232 analyzes voice inputted from the voice input/output unit 113 of the terminal device 32 via the dialog recording unit 55, performs conversion into text information, for example, and outputs to the command interpretation unit 234.

The tap analysis unit 233 analyzes operation input information inputted by a tap operation on the operation display unit 112, obtains operation input information such as an inputted character or a selected operation button, for example, and outputs to the command interpretation unit 234.

The command interpretation unit 234 interprets a user command on the basis of the text information supplied from the voice analysis unit 232 or the operation input information supplied from the tap analysis unit 233, and outputs command information, which is an interpretation result, to the output unit 235.

The output unit 235 outputs the command information supplied from the command interpretation unit 234 to the policy detail acquisition unit 58 or the consent/refusal management unit 59, in accordance with a content of the command. More specifically, when the interpretation result of the command is a policy detail acquisition command, the output unit 235 outputs to the policy detail acquisition unit 58. Furthermore, when the interpretation result of the command is a command indicating consent or refusal, the output unit 235 outputs to the consent/refusal management unit 59.

<Configuration Example of Policy Detail Acquisition Unit>

Next, a configuration example of the policy detail acquisition unit 58 will be described with reference to the block diagram of FIG. 11.

The policy detail acquisition unit 58 includes a control unit 271, a policy detail reading unit 272, and a description generation unit 273.

The control unit 271 includes a processor and a memory, and controls the entire operation of the policy detail acquisition unit 58. Furthermore, the control unit 271 outputs a policy detail acquisition command supplied from the instruction analysis unit 57, to the policy detail reading unit 272.

On the basis of the policy detail acquisition command supplied from the control unit 271, the policy detail reading unit 272 reads out information of the policy item group 71 instructed to be read from the policy item management unit 52, and outputs to the description generation unit 273.

On the basis of the information of the policy item group 71 read in response to the policy detail acquisition command, the description generation unit 273 generates a description recognizable as a sentence by a human being, and outputs to the terminal device 32 via the dialog recording unit 55.

<Configuration Example of Consent/Refusal Management Unit>

Next, a configuration example of the consent/refusal management unit 59 will be described with reference to the block diagram of FIG. 12.

The consent/refusal management unit 59 includes a control unit 291, a consent/refusal notification unit 292, and a consent/refusal history recording unit 293.

The control unit 291 includes a processor, a memory, and the like, and controls the entire operation of the consent/refusal management unit 59. Furthermore, the control unit 291 outputs a command regarding consent or refusal supplied from the instruction analysis unit 57, to the consent/refusal notification unit 292 and the consent/refusal history recording unit 293.

On the basis of the command regarding consent or refusal, the consent/refusal notification unit 292 outputs notification of consent or refusal to the target service providing device 34. At this time, the consent/refusal notification unit 292 performs conversion into a command of a communication method of the service providing device 34, and outputs. More specifically, the consent/refusal notification unit 292 includes communication format conversion units 311-1 to 311-n and a standardized communication format conversion unit 312.

The communication format conversion units 311-1 to 311-n perform conversion into a command in a dedicated communication format for various service providing devices 34.

The standardized communication format conversion unit 312 converts the command into a standardized communication format for the service providing device 34.

The consent/refusal history recording unit 293 reads out, from the dialog history storage unit 56, a dialog history until information about consent or refusal is identified on the basis of the command regarding consent or refusal, associates the information about consent or refusal regarding a privacy policy with the dialog history until the consent or refusal is identified, and causes the consent/refusal history storage unit 60 to store. That is, by associating and storing information of the dialog exchanged at a time of consent or permission for the privacy policy with the consent/refusal history storage unit 60 in this way, an evidence for consent or refusal for the privacy policy is obtained.

Note that, for the privacy policy storage unit 33, the service providing device 34, the policy item analysis unit 51, the policy item management unit 52, the policy analysis unit 53, the summary generation unit 54, the dialog recording unit 55, the dialog history storage unit 56, the instruction analysis unit 57, the policy detail acquisition unit 58, the consent/refusal management unit 59, and the consent/refusal history storage unit 60, all or part of them each may be realized by a server computer or cloud computing. Therefore, the privacy policy agent device 31 itself may also be realized by a server computer or cloud computing. Moreover, the privacy policy agent device 31 that forms the privacy policy agent system 11 of FIG. 1, the privacy policy storage unit 33, and the service providing device 34 may also be configured by a plurality of server computers as a whole, or may also be realized by cloud computing.

<Policy Item Analyzing Process>

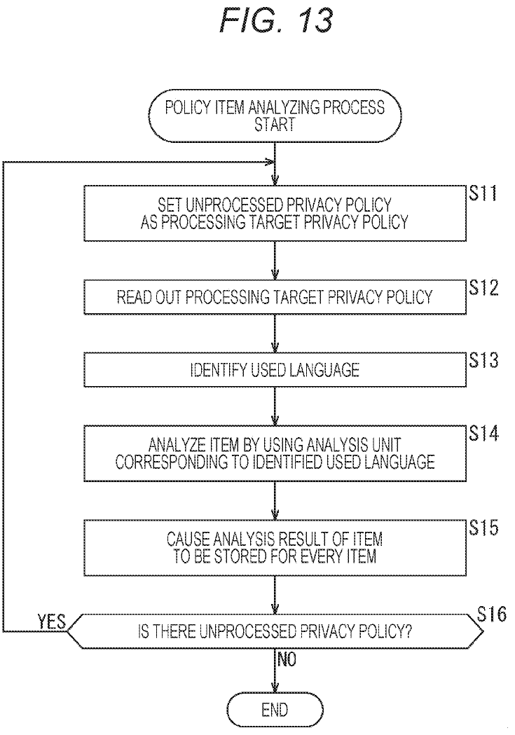

Next, a policy item analyzing process will be described with reference to a flowchart of FIG. 13. Note that this process is on the premise that information of the privacy policy 91 supplied from the service providing device 34 is stored in the privacy policy storage unit 33 in advance.

In step S11, the privacy policy reading unit 132 is controlled by the control unit 131 to set an unprocessed privacy policy 91 as a processing target privacy policy 91.

In step S12, the privacy policy reading unit 132 reads out the processing target privacy policy 91 from the privacy policy storage unit 33, and outputs to the item analysis unit 133.

In step S13, the item analysis unit 133 is controlled by the control unit 131 to identify a language used in the processing target privacy policy 91. The item analysis unit 133 supplies the processing target privacy policy 91 to and causes, for example, each of the natural language analysis unit 141, the JSON/XML analysis unit 142, and the HTML analysis unit 143, to analyze and identify the used language.

In step S14, among the natural language analysis unit 141, the JSON/XML analysis unit 142, and the HTML analysis unit 143, to analyze an item of the processing target privacy policy 91, the item analysis unit 133 causes an analysis unit corresponding to the identified language.

In step S15, the item analysis unit 133 causes the output unit 134 to output an item analysis result of the processing target privacy policy 91 in the identified language, among the natural language analysis unit 141, the JSON/XML analysis unit 142, and the HTML analysis unit 143. The output unit 134 is controlled by the control unit 131 to cause the item analysis result to be outputted to the policy item management unit 52 and stored as the policy item group 71 as described with reference to FIG. 6.

In step S16, the privacy policy reading unit 132 determines whether or not an unprocessed privacy policy 91 is stored in the privacy policy storage unit 33. In a case where the unprocessed privacy policy 91 is stored, the process returns to step S11. That is, the processing of steps S11 to S16 is repeated until there is no more unprocessed privacy policy 91 in the privacy policy storage unit 33.

Then, an item analyzing process is performed from all the privacy policies 91 stored in the privacy policy storage unit 33. In a case where it is regarded that the unprocessed privacy policy 91 is not stored in the privacy policy storage unit 33, the process is terminated.

By the above processing, the policy item analyzing process is performed on all the privacy policies 91 registered by an organizer who manages and operates the service providing device 34, which causes the policy item management unit 52 to store the policy item group 71 in which the items are analyzed.

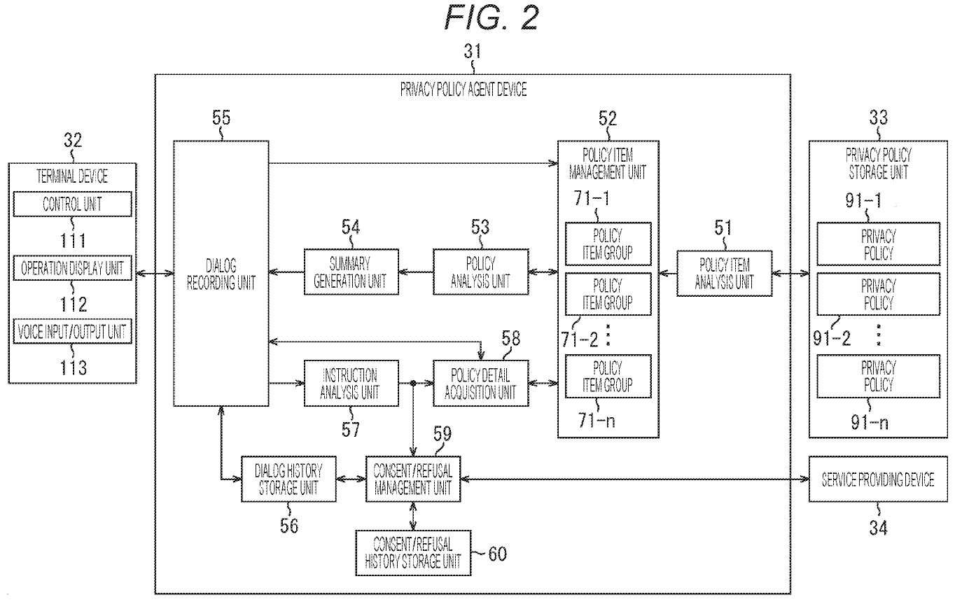

Note that, in the above, a description has been given to an example of performing the policy item analyzing process on all the privacy policies 91 stored in the privacy policy storage unit 33. However, the policy item analyzing process may be performed only at a timing when a new privacy policy 91 is newly stored in the privacy policy storage unit 33, or a timing when the privacy policy 91 is updated.

<Privacy Policy Agent Process by Privacy Policy Agent Device 31 of FIG. 2>

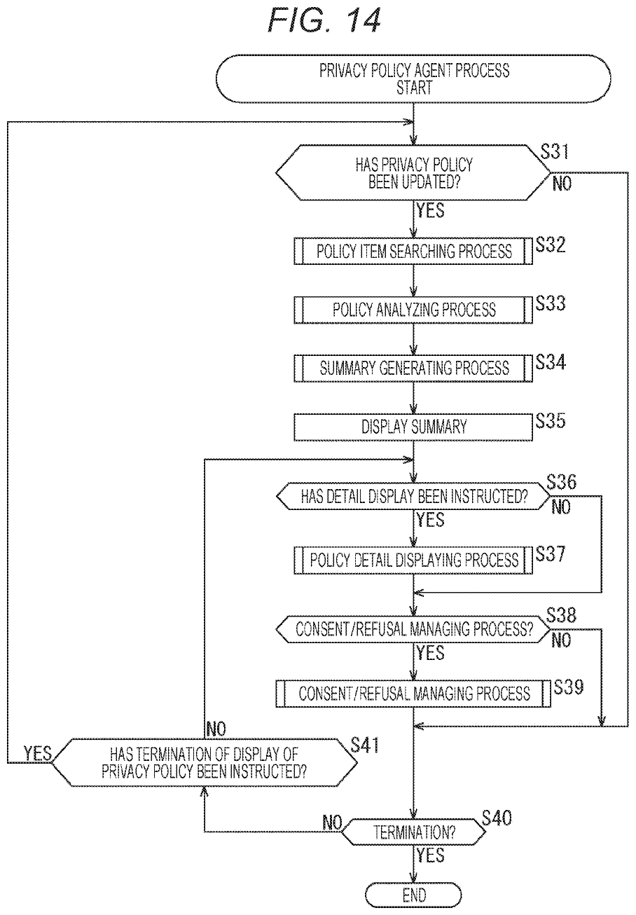

Next, a privacy policy agent process by the privacy policy agent device 31 of FIG. 2 will be described with reference to a flowchart of FIG. 14.

Note that, the privacy policy agent process in FIG. 14 is on the premise that the policy item management unit 52 stores the policy item group 71 by the policy item analyzing process described with reference to the flowchart of FIG. 13.

Furthermore, in this process, a description is given to an example of, when the privacy policy is updated, comparing and presenting the policy item group 71 for the privacy policy before the update and the policy item group 71 for the privacy policy after the update, but the policy item groups 71 having other relationships may be compared and presented.

In step S31, the control unit 152 of the policy item management unit 52 determines whether or not any of the policy item groups 71 stored in the policy item group storage unit 151 has been updated. In step S31, for example, for any of the policy item groups 71, when the policy item group 71 of the updated privacy policy corresponding to the policy item group 71 for a registered privacy policy is stored, it is regarded that there is update, and the process proceeds to step S32.

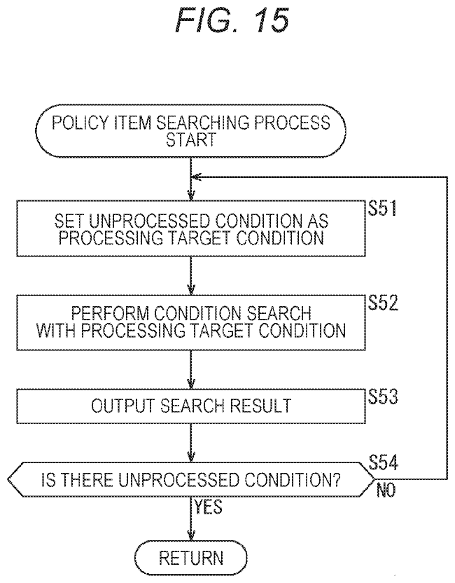

In step S32, the control unit 152 executes a policy item searching process, to search for the policy item group 71 corresponding to the updated privacy policy and the policy item group 71 corresponding to the privacy policy before the update from the policy item group storage unit 151, output to the output unit 153, and output to the policy analysis unit 53. Note that the policy item searching process will be described later in detail with reference to a flowchart of FIG. 15.

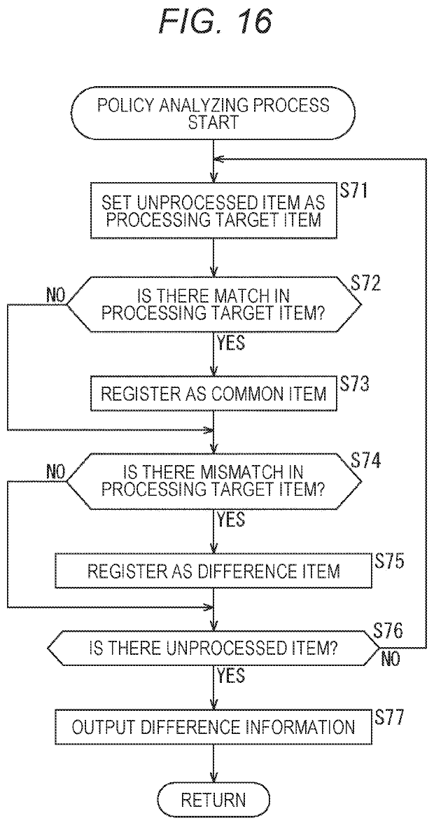

In step S33, the policy analysis unit 53 executes a policy analyzing process, to analyze the policy item group of the privacy policy on the basis of a policy item search result supplied from the policy item management unit 52, and output an analysis result including difference information to the summary generation unit 54. Note that the policy analyzing process will be described later in detail with reference to a flowchart of FIG. 16.

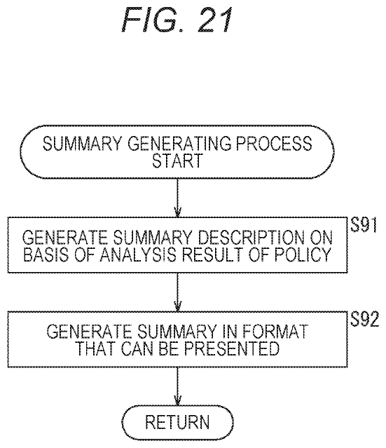

In step S34, the summary generation unit 54 executes a summary generating process, to generate summary information from the difference information that is the analysis result supplied from the policy analysis unit 53, and transmit to the terminal device 32 via the dialog recording unit 55. Note that the summary generating process will be described later in detail with reference to a flowchart of FIG. 21. Furthermore, at this time, every time various data are made between the privacy policy agent device 31 and the terminal device 32, the dialog recording unit 55 always stores as a dialog history in the dialog history storage unit 56, but the description will be omitted in the following description.

In step S35, the control unit 111 of the terminal device 32 causes the operation display unit 112 to display a summary of the privacy policy on the basis of the summary information supplied from the privacy policy agent device 31.

In step S36, the instruction analysis unit 57 determines whether or not a command requesting detail display of the privacy policy has been transmitted via the dialog recording unit 55 by an operation on the operation display unit 112 of the terminal device 32 or voice utterance to the voice input/output unit 113. That is, when a command transmitted from the terminal device 32 is transmitted via the dialog recording unit 55, the instruction analysis unit 57 analyzes a content of the command and determines whether or not to be a command requesting detail display of the privacy policy.

In step S36, for example, in a case where, with a voice summary by the processing of step S35, a summary of “Purchase history is provided to the shop side in the A mail order. Purchase statistics are provided externally in the A mail order and the C mail order.” is presented, and then the user utters a command such as “What is the form of the purchase statistics?”, it is regarded that there has been a request for more detailed information as the form of the purchase statistics, while it has been only disclosed that the purchase statistics are provided externally in the first summary. Therefore, it is regarded that there is the command requesting the detail display of the privacy policy, and the process proceeds to step S37.

In step S37, the instruction analysis unit 57 outputs the command requesting the detail display of the privacy policy, to the policy detail acquisition unit 58. More specifically, the instruction analysis unit 57 outputs, to the policy detail acquisition unit 58, a command instructing to read out detailed information regarding the purchase statistics corresponding to the command such as “What is the form of the purchase statistics?”. The policy detail acquisition unit 58 executes a policy detail acquiring process to acquire the policy item group 71 from the corresponding policy item management unit 52, and transmits to the terminal device 32 via the dialog recording unit 55. That is, in a case of a command such as “What is the form of the purchase statistics?”, the policy detail acquisition unit 58 acquires policy detail information regarding the purchase statistics and transmits to the terminal device 32 via the dialog recording unit 55.

By this processing, the control unit 111 of the terminal device 32 causes the operation display unit 112 to display predetermined information in the policy item group 71 that is the transmitted detailed information of the privacy policy, without summarizing.

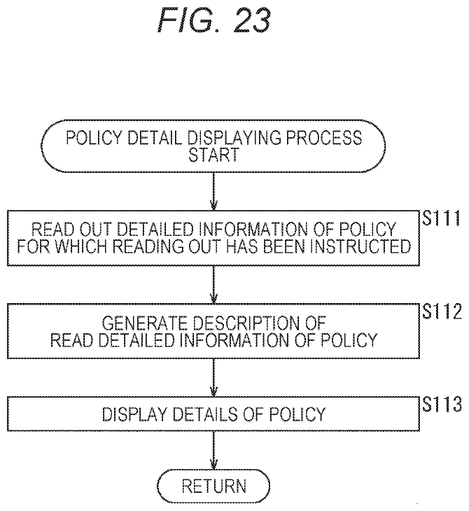

Note that a detail displaying process will be described later in detail with reference to a flowchart of FIG. 23. Furthermore, in step S36, in a case where the command requesting the detail display of the privacy policy has not been transmitted, the processing of step S37 is skipped.

In step S38, in response to an operation performed on the operation display unit 112 of the terminal device 32, the instruction analysis unit 57 determines whether or not a command regarding consent or refusal for the privacy policy has been transmitted via the dialog recording unit 55. That is, when a command transmitted from the terminal device 32 is transmitted via the dialog recording unit 55, the instruction analysis unit 57 analyzes a content of the command, and determines whether or not to be the command regarding consent or refusal for the privacy policy.

In step S38, in a case where the command regarding consent or refusal for the privacy policy is transmitted, the process proceeds to step S39.

In step S39, the instruction analysis unit 57 outputs the command regarding consent or refusal to the consent/refusal management unit 59. The consent/refusal management unit 59 executes a consent/refusal managing process to acquire the transmitted command regarding consent or refusal, transmits a notification indicating either consent or refusal to the service providing device 34, and causes the consent/refusal history storage unit 60 to store the notification indicating either consent or refusal.

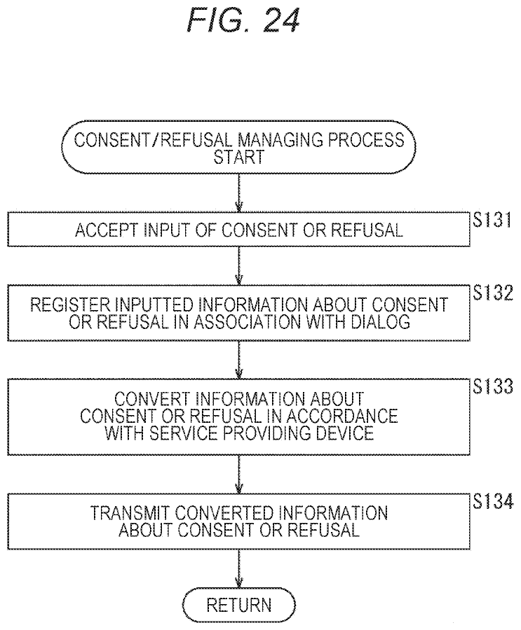

Note that the consent/refusal managing process will be described later in detail with reference to a flowchart of FIG. 24. Furthermore, in step S38, in a case where no command regarding consent or refusal for the privacy policy has been transmitted, the processing of step S39 is skipped.

In step S40, the policy item management unit 52 determines whether or not termination of the privacy policy agent process has been instructed, and the process proceeds to step S41 in a case of not termination.

In step S41, the policy item management unit 52 determines whether or not termination of display of the current privacy policy has been instructed, and the process returns to step S36 in a case where the termination has not been instructed. That is, after the display of the privacy policy is instructed, the summary is displayed, and the processing of steps S36 to S41 is repeated. Then, in step S41, when termination of the display of the current privacy policy is instructed, the process returns to step S31. However, in a case where a privacy policy is not updated in the first process, since there is no privacy policy that is being displayed, it is considered that termination of the display of the privacy policy is instructed in step S41, and the process returns to step S31.

That is, the processing of steps S31 to S41 is repeated until termination of the privacy policy agent process is instructed.

In step S40, when termination of the privacy policy agent process is instructed, the process is terminated.

By the above processing, when a privacy policy is updated, difference information of the corresponding privacy policies before and after the update is generated as an analysis result from the privacy policy agent device 31, and a summary can be generated and displayed on the basis of the difference information.

Furthermore, regarding the privacy policy displayed as the summary, in a case where detailed checking is further desired, it is possible to display detailed information of the privacy policy by the user operating the terminal device 32 to instruct the privacy policy agent device 31 to display detailed information of the privacy policy as a command.

Moreover, the user can transmit a command specifying consent or refusal from the terminal device 32 to the privacy policy agent device 31 by operating the operation display unit 112 on the basis of the displayed summary. Moreover, the user can set consent or refusal for the privacy policy related to service provision, through the transmission of the transmitted information regarding consent or refusal to the service providing device 34.

<Policy Item Searching Process>

Next, the policy item searching process will be described with reference to the flowchart of FIG. 15.

In step S51, among search conditions of the policy item group 71 corresponding to the privacy policies before and after update, the control unit 152 sets an unprocessed search condition as a processing target condition. More specifically, for example, in a case where the privacy policy for receiving service provision of the A mail order is updated, a search condition for the privacy policy before the update and the privacy policy after the update includes two types of the privacy policy before update and the privacy policy after the update of the A mail order, and therefore the unprocessed condition in any of the conditions is set as the processing target condition.

In step S52, the control unit 152 performs a condition search of the policy item group 71 in the policy item group storage unit 151, in accordance with the processing target condition.

In step S53, the control unit 152 reads out information of the policy item group 71 that is to be a search result, and outputs to the policy analysis unit 53.

In step S54, the control unit 152 determines whether or not an unprocessed search condition is present, and the process returns to step S51 in the case of being present. That is, the processing of steps S51 to S54 is repeated until there is no more unprocessed search condition. That is, the policy item group 71 before the update and the policy item group 71 after the update are repeatedly searched for.

Then, in step S54, in a case where it is determined that there is no unprocessed search condition, the process is terminated.

That is, by the above processing, regarding the search condition corresponding to the privacy policy after the update and the privacy policy before the update, among the policy item groups 71 stored in the policy item group storage unit 151, all the policy item groups 71 are read and outputted to the policy analysis unit 53.

<Policy Analyzing Process>

Next, the policy analyzing process will be described with reference to the flowchart of FIG. 16.

In step S71, the each-item comparison unit 172 sets an unprocessed item as a processing target item. Up to this point, an example has been described in which the policy item groups 71 corresponding to the privacy policy of the same service before and after update are searched for. However, considering that mutually different points are updated contents, processing is to be similar even in the policy item groups 71 for different services. Therefore, here, a case is considered in which the search is performed in accordance with the search condition, on the assumption that the policy item groups 71 of the A mail order and the C mail order shown in FIG. 6 are the policy item groups 71 before and after update of the privacy policy for the same service. In the case of FIG. 6, regarding items, any unprocessed item is set as the processing target item out of 5 types of items of internal use of the purchase history, external provision of the purchase history, internal use of the purchase statistics, external statistics of the purchase statistics (to=shop), and external provision of the purchase statistics (to=partner company) in the figure.

In step S72, the each-item comparison unit 172 determines whether or not there is a match in the processing target item. That is, for example, in the case of FIG. 6, in a case where the processing target item is the internal use of the purchase history in the figure, the point of using with anonymization is the match in both the A mail order and the C mail order, and therefore it is regarded that there is a match, and the process proceeds to step S73.

In step S73, the each-item comparison unit 172 outputs the match in the processing target items to the difference information generation unit 173. The difference information generation unit 173 registers the match in the processing target items as a common item. That is, in the case of FIG. 6, in a case where the processing target item is the internal use of the purchase history in the figure, the point that anonymization is not performed is the match in both the A mail order and the C mail order. Therefore, the difference information generation unit 173 registers, as the difference information, that anonymization is not performed for the internal use of the purchase history (common item⋅purchase history: internal use: anonymous=0), as shown in the common item in FIG. 8.

Note that, in a case where there is no match in step S72, the processing of step S73 is skipped.

In step S74, the each-item comparison unit 172 determines whether or not there is a mismatch in the processing target item. That is, for example, in the case of FIG. 6, in a case where the processing target item is the external provision of the purchase history in the figure, it is regarded that there is a mismatch since the provision is made with anonymization to the shop operator side in the A mail order while there is no external provision in the C mail order, and the process proceeds to step S75.

In step S75, the each-item comparison unit 172 outputs the mismatch in the processing target items to the difference information generation unit 173. The difference information generation unit 173 registers the mismatch in the processing target items as a difference item. That is, in the case of FIG. 6, in a case where the processing target item is the external provision of the purchase history in the figure, the provision is made with anonymization to the shop operator side in the A mail order while there is no external provision in the C mail order. Therefore, it is registered that, as difference information, provision is made without anonymization for external provision of the purchase history in the A mail order, as shown by the difference item in FIG. 8 (difference item⋅purchase history: external provision: A mail order: shop: anonymous=1).

Note that, in a case where there is no mismatch in step S74, the processing of step S75 is skipped.

In step S76, the each-item comparison unit 172 determines whether or not there is an unprocessed item, and the process returns to step S71 in a case where there is an unprocessed item. That is, the processing of steps S71 to S76 is repeated until there is no more unprocessed item. Then, in a case where it is regarded in step S76 that there is no unprocessed item, the process proceeds to step S77.

In step S77, the difference information generation unit 173 outputs the difference information to the summary generation unit 54, and the process is terminated.

By the above processing, contents of the policy item groups before and after update of the updated privacy policy are compared, and difference information including a difference item and a common item is generated and outputted to the summary generation unit 54 as an analysis result.

<Specific Example of Generating Difference Information by Using Policy Item Group>

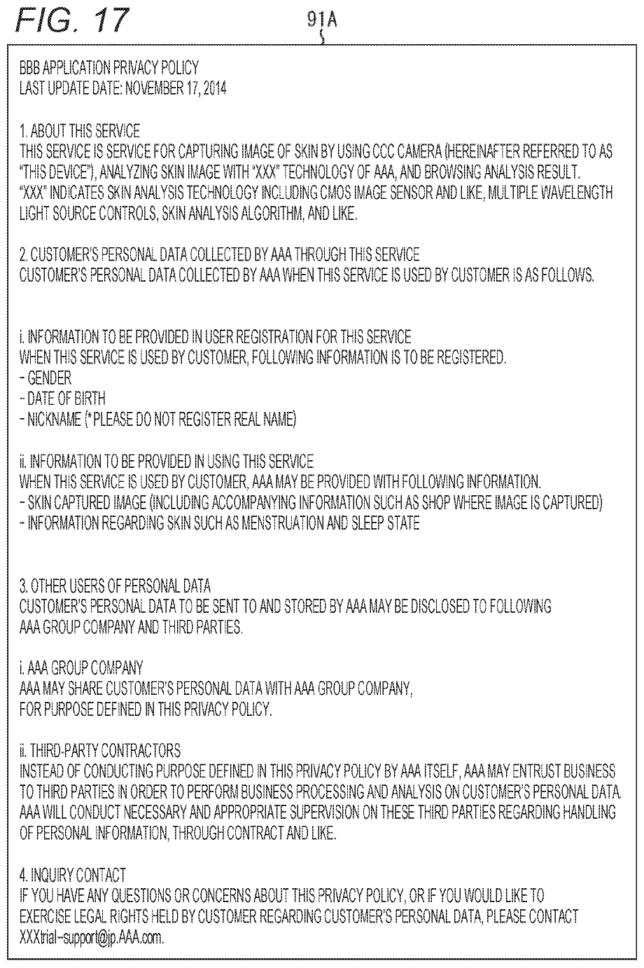

Here, with reference to FIGS. 17 to 20, a description will be given to a specific example of generating difference information by using a policy item group.

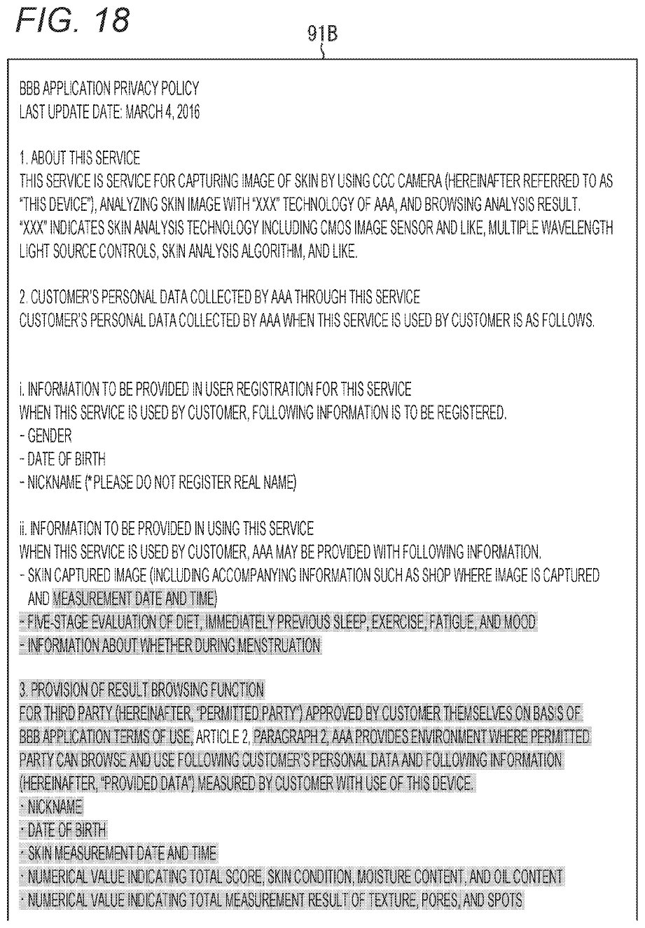

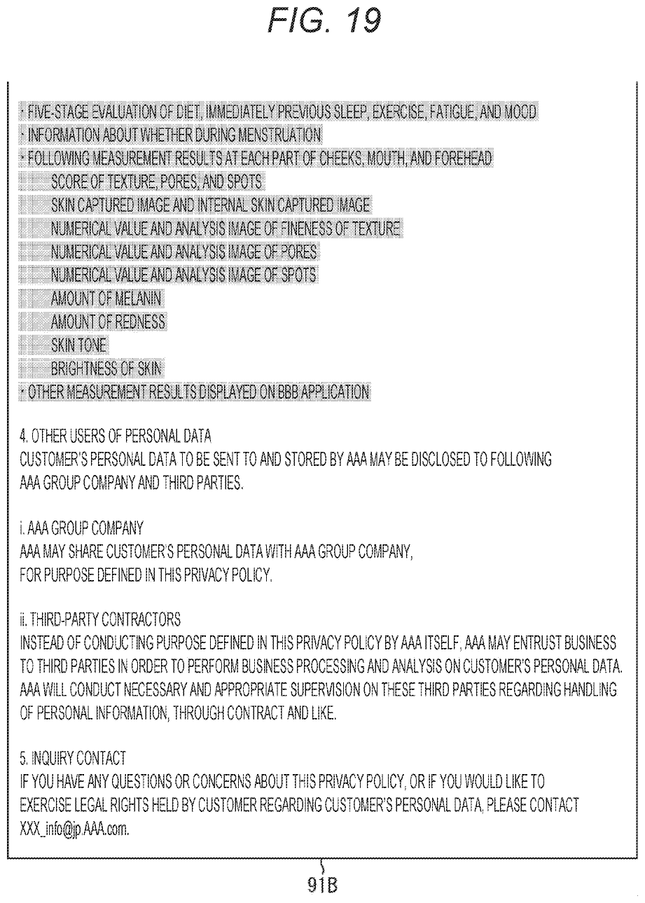

For example, consider a case where a policy item group 71A of a privacy policy 91A shown in FIG. 17 and a policy item group 71B of a privacy policy 91B shown in FIGS. 18 and 19 are read out. Note that the privacy policy 91A and the privacy policy 91B are set for the same service, and the privacy policy 91B is obtained by updating the privacy policy 91A.

Therefore, the difference information includes a difference item and a common item corresponding to updated contents of the privacy policy 91A before the update and the privacy policy 91B after the update.

The privacy policy 91A in FIG. 17 includes four articles of “1. About this service”, “2. Customer's personal data collected by AAA through this service”, “3. Other users of personal data”, and “4. Inquiry contact”.

On the other hand, the privacy policy 91B shown in FIGS. 18 and 19 includes five articles of “1. About this service”, “2. Customer's personal data collected by AAA through this service”, “3. Provision of result browsing function”, “4. Other users of personal data”, and “5. Inquiry contact”.

That is, in the updated privacy policy 91B, a point different from the privacy policy 91A is parts for which background is colored in FIGS. 18 and 19, that is, “Measurement date and time”, “—Five-stage evaluation of diet, immediately previous sleep, exercise, fatigue, and mood”, “—Information about whether during menstruation”, and “3. Provision of result browsing function”.

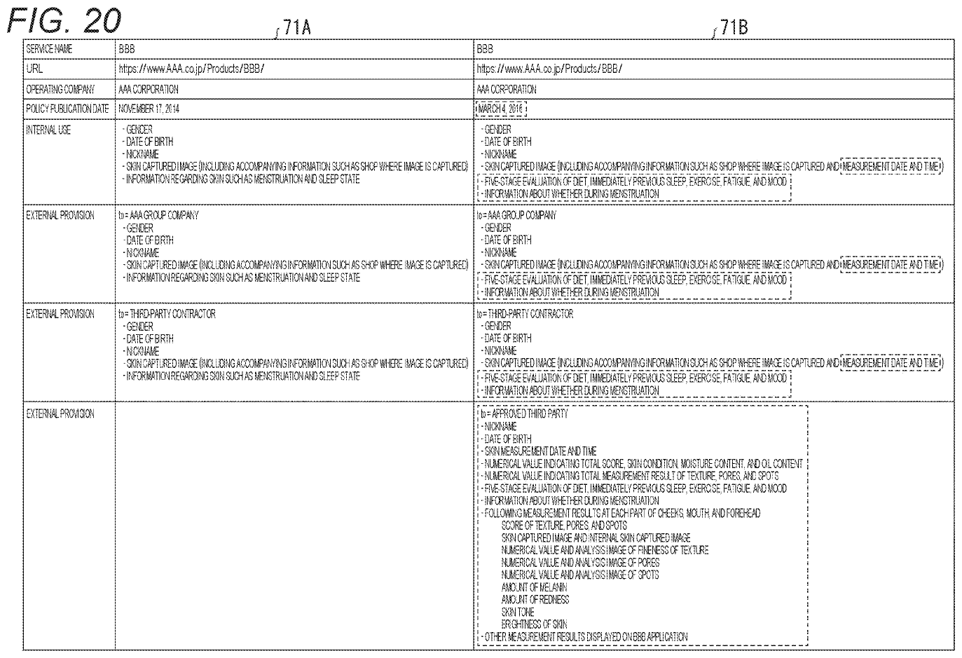

The policy item groups 71A and 71B in such the privacy policy 91A before the update shown in FIG. 17 and the privacy policy 91B after the update shown in FIGS. 18 and 19 are to be, for example, as shown in FIG. 20.

Furthermore, in FIG. 20, items of each policy item group are arranged in a vertical direction, and for the same service, the policy item group 71A before update is arranged on a left side in the figure, and the updated policy item group 71B is arranged on a right side in the figure, in a horizontal direction.

Note that items are arranged in the vertical direction in the policy item groups 71A and 71B in FIG. 20, and for the same service, policy item groups before and after update are arranged in the horizontal direction. In this case, policy item groups for different services may be arranged. On the other hand, the policy item group described with reference to FIG. 6 has items arranged in the horizontal direction and different services arranged in the vertical direction. Also in the policy item group of FIG. 6, regarding the service, policy item groups before and after update for the same service may be arranged.

That is, in the policy item group of FIG. 6 and the policy item group of FIG. 20, the services and items arranged in the horizontal direction and the vertical direction are only swapped, and the policy item groups of FIG. 6 and the policy item groups of FIG. 20 are substantially the same.

That is, the policy item groups 71A and 71B in FIG. 20 are provided with items of, for example, from the top, service name, URL, operating company, policy publication date, internal use, external provision (to=AAA group company), external provision (to=third-party contractor), and external provision (to=approved third party).

In FIG. 20, the item of service name is “BBB”, the item of URL is “https://www.AAA.co.jp/Products/BBB/”, the item of operating company is “AAA Corporation”, and the item of policy publication date is “Nov. 17, 2014” for before update and “Mar. 4, 2016” for after update.

The item of internal use includes, for before update, “—Gender”, “—Date of birth”, “—Nickname”, “—Skin captured image (including accompanying information such as the shop where the image is captured)”, and “—Information regarding skin such as menstruation and sleep state”.

Furthermore, the item of internal use includes, for after update, “—Gender”, “—Date of birth”, “—Nickname”, “—Skin captured image (including accompanying information such as the shop where the image is captured)”, “—Skin captured image (including accompanying information such as the shop where the image is captured and measurement date and time)”, “—Five-stage evaluation of diet, immediately previous sleep, exercise, fatigue, and mood”, and “—Information about whether during menstruation”.

Moreover, the items of external use (to=AAA group company and third-party contractor) both include, for before the update, “—Gender”, “—Date of birth”, “—Nickname”, “—Skin captured image (including accompanying information such as the shop where the image is captured)”, and “—Information regarding skin such as menstruation and sleep state”.

Furthermore, the items of external use (to=AAA group company and third-party contractor) both include, for after the update, “—Gender”, “—Date of birth”, “—Nickname”, “—Skin captured image (including accompanying information such as the shop where the image is captured and measurement date and time)”, “—Five-stage evaluation of diet, immediately previous sleep, exercise, fatigue, and mood”, and “—Information about whether during menstruation”.

Moreover, the item of external use (to=approved third party), which is for only after update, includes “—Nickname”, “—Date of birth”, “—Skin measurement date and time”, “-Numerical value indicating total score, skin condition, moisture content, and oil content” “—Numerical value indicating total measurement result of texture, pores, and spots”, “—Five-stage evaluation of diet, immediately previous sleep, exercise, fatigue, and mood”, “—Information about whether during menstruation”, “—Following measurement results at each part of cheeks, mouth, and forehead”, “Score of texture, pores, and spots”, “Skin captured image and internal skin captured image”, “Numerical value and analysis image of fineness of texture”, “Numerical value and analysis image of pores”, “Numerical value and analysis image of spots”, and “Amount of melanin”, “Amount of redness”, “Skin tone”, and “Brightness of skin”, and “—Other measurement results displayed on BBB application”.

Note that, in the policy item groups 71A and 71B of FIG. 20, difference items after update that differ from contents before update are indicated by being surrounded by dotted line frames.

In FIG. 20, in each item of the policy item groups 71A and 71B of the privacy policies 91A and 91B before and after update, descriptions not surrounded by the dotted line frames represent common items having no change, and descriptions surrounded by the dotted line frames represent difference items having a change.

Therefore, in the case of the policy item groups 71A and 71B of FIG. 20, for difference information, information written out in a format as shown in FIG. 8 is to be the difference information, on the basis of information of common items and information of difference items according to the presence/absence of a change in each item of the policy item groups 71A and 71B of the privacy policies 91A and 91B before and after update.

<Summary Generating Process>

Next, the summary generating process will be described with reference to the flowchart of FIG. 21.

In step S91, the summary description generation unit 192 of the summary generation unit 54 generates a summary description on the basis of difference information supplied from the policy analysis unit 53, and outputs to the summary information generation unit 193.

For example, in the case of the difference information in FIG. 8, the summary description generation unit 192 generates a summary description corresponding to the difference information, such as, for example, “Regarding the difference item, there is provision to the shop side in the A mail order for the purchase history, and there is provision to the partner in the A mail order and the C mail order for the purchase statistics, and regarding the common item, there is internal usage for the purchase history, there is internal use for the purchasing statistics, and there is provision to the shop side for the purchase statistics”.

In step S92, the summary information generation unit 193 generates summary information in a format that can be presented in the terminal device 32.

More specifically, in the first process, the summary information generation unit 193 inquiries about the format that can be presented to the terminal device 32 via the dialog recording unit 55, acquires information about a format that can be presented, and generates summary information in the corresponding format.

That is, for example, in a case where presentation in a voice format is possible in the terminal device 32, the summary information generation unit 193 controls the voice summary generation unit 211 to generate summary information including a voice summary in the voice data format obtained by converting the summary description into voice, and transmits to the terminal device 32 via the dialog recording unit 55. In this case, the control unit 111 of the terminal device 32 acquires the summary information in the voice data format, and outputs the summary of the privacy policy by voice from the voice input/output unit 113. For example, in the case of the example shown in FIG. 6, a summary by voice such as reading of “Purchase history is provided to the shop operator side in the A mail order. Purchase statistics are provided externally in the A mail order and the C mail order.” is outputted.

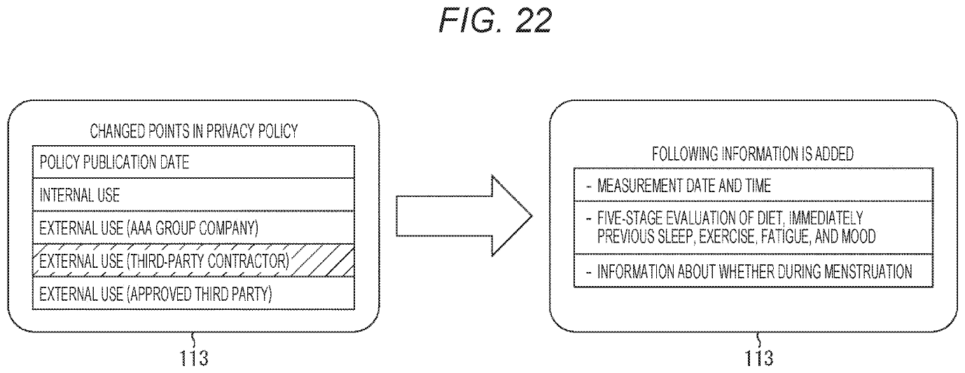

Furthermore, for example, in a case where a display area of the operation display unit 112 is small in the terminal device 32, the summary information generation unit 193 controls the simple list summary generation unit 212 to generate summary information including a simple list summary from the summary description, and transmits to the terminal device 32 via the dialog recording unit 55. In this case, the control unit 111 of the terminal device 32 acquires the summary information including the simple list summary, and, for example, outputs the summary of the privacy policy as a simple list image as shown in a left part of FIG. 22, on the operation display unit 112. The left part of FIG. 22 displays, as changed points in the privacy policy, a list including, from the top, “Policy publication date”, “Internal use”, “External provision (AAA group company)”, “External provision (third-party contractor)”, and “External provision (approved third party)”.

However, in this case, since the display area of the operation display unit 112 is small and the display content is only the simple list image, corresponding detailed information can be displayed by selecting any of the items in the list. That is, as shown in the left part of FIG. 22, for example, when a hatched display part of “External provision (third-party contractor)” is tapped and the operation display unit 112 is operated, or when “External provision (third-party contractor)” is specified by voice utterance, correspondingly, a list of changed points in “External provision (third-party contractor)” is displayed as detailed information as shown in a right part of FIG. 22.

Note that, the right part of FIG. 22 displays “Following information is added”, and displays that, from the top, “—Measurement date and time”, “—Five-stage evaluation of diet, immediately previous sleep, exercise, fatigue, and mood”, and “—Information about whether during menstruation” are items newly added to “External provision (third-party contractor)”.

Furthermore, for example, in a case where the display area of the operation display unit 112 is further small in the terminal device 32, the summary information generation unit 193 controls the icon summary generation unit 213 to generate summary information including an icon summary, and transmits to the terminal device 32 via the dialog recording unit 55.

Moreover, for example, in a case where the display area of the operation display unit 112 is sufficiently large in the terminal device 32, the summary information generation unit 193 controls the item group full display summary generation unit 214 to generate summary information including a full display summary for full text display of the summary description, and transmits to the terminal device 32 via the dialog recording unit 55. In this case, the control unit 111 of the terminal device 32 acquires a full display summary for full display of the summary description, and outputs the summary of the privacy policy as an image on the operation display unit 112. In this case, while the full text of the summary description is displayed, a list of policy item groups, for example, as shown in FIG. 20, may be displayed with a frame indicated by a dotted line for the updated part. Moreover, only the updated part surrounded by the dotted line in FIG. 20 may be displayed.

Moreover, for the terminal device 32 that can present summary information by a plurality of methods among these, for example, the voice and the full-text image may be presented at the same time by generating summary information including the voice data and the full text, and transmitting to the terminal device 32.

By the above processing, summary information in a format that can be presented by the terminal device 32 is generated and transmitted to the terminal device 32, and the summary information can be presented. In the summary information presented here, since items that have changed are to be intensively presented by voice and image for before and after update of the privacy policy, a changed point can be properly recognized even without reading of a redundant and difficult privacy policy, which enables determination of consent or refusal for the privacy policy to be accurate, easy, and quick.

<Policy Detail Displaying Process>

Next, a policy detail displaying process will be described with reference to the flowchart of FIG. 23.

In step S111, the control unit 271 instructs the policy detail reading unit 272 to read out detailed information of the privacy policy for which the instruction analysis unit 57 has instructed presentation of the detailed information. The policy detail reading unit 272 requests the policy item management unit 52 for the detailed information of the privacy policy for which presentation of the detailed information is instructed. In response to this, from the policy item group storage unit 151, the control unit 152 of the policy item management unit 52 reads out information specified by the specified policy item group 71, and transmits to the policy detail acquisition unit 58. The policy detail reading unit 272 of the policy detail acquisition unit 58 acquires the policy item group 71 transmitted from the policy item group storage unit 151, and outputs to the description generation unit 273.

That is, in a case where the summary of “Purchase history is provided to the shop operator side in the A mail order. Purchase statistics are provided externally in the A mail order and the C mail order.” is presented by a voice summary, and then the user utters a command such as “What is the form of the purchase statistics?”, the policy detail reading unit 272 of the policy detail acquisition unit 58 acquires information regarding the purchase statistics in the corresponding policy item group from the policy item group storage unit 151.

In step S112, the description generation unit 273 generates a description of the acquired information about the form of the purchase statistics in the policy item group 71 that corresponds to the command and for which detail display is requested, and transmits to the terminal device 32 via the dialog recording unit 55.

In step S113, the information for which the detail display has been instructed is presented on the operation display unit 112 of the terminal device 32, or outputted by voice from the voice input/output unit 113. That is, for example, in a case of a command by voice such as “What is the form of the purchase statistics?”, for example, in the case of FIG. 6, detailed information such as “Anonymized individual statistics in the A mail order, and overall statistics in the C mail order” is presented by voice.

By the above processing, in the privacy policy displayed as the summary information, for information that is not presented as the summary, the information of the policy item group 71 is directly read out and displayed by the user requesting a content of the privacy policy desired to be presented with a command. As a result, it becomes possible for the user to check details of a concerned part while grasping the entire privacy policy by the summary.

<Consent/Refusal Managing Process>

Next, the consent/refusal managing process will be described with reference to the flowchart of FIG. 24.

In step S131, the control unit 291 accepts an input of a command regarding consent or refusal for the privacy policy.

In step S132, the control unit 291 reads out inputted information about consent or refusal for the privacy policy, the consent/refusal history recording unit 293 reads out a corresponding dialog history in the dialog history storage unit 56, and the read dialog history and a consent/refusal history are associated and stored in the consent/refusal history storage unit 60.

In step S133, the control unit 291 outputs the information about consent or refusal for the privacy policy to the consent/refusal notification unit 292. The consent/refusal notification unit 292 converts the information about consent or refusal for the privacy policy in accordance with a communication format of the service providing device 34 of the privacy policy, which is to be a transmission destination.

More specifically, in accordance with the communication form of the service providing device 34 that provides the service corresponding to the privacy policy and is to be the transmission destination, the consent/refusal notification unit 292 selects and causes either the communication format conversion units 311-1 to 311-n or the standardized communication format conversion unit 312 to convert the communication format.

In step S134, the consent/refusal notification unit 292 transmits the information that is about consent or refusal for the privacy policy and has been converted into the appropriate communication form, to the service providing device 34.

By this processing, it becomes possible to appropriately notify the service providing device 34 in various communication forms, of information about consent or refusal for the privacy policy.

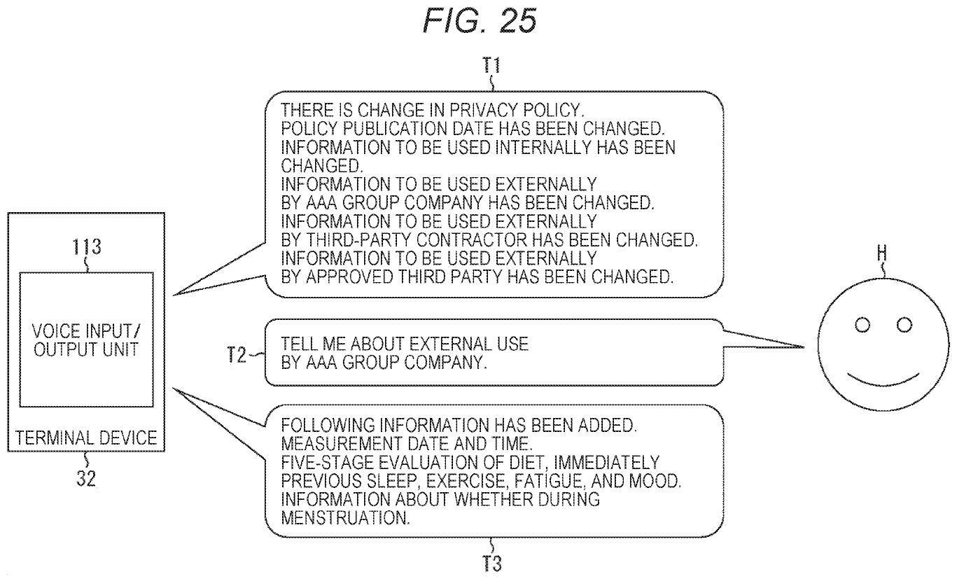

By the above processing, it becomes possible to recognize update of the privacy policy in a dialog format as shown in FIG. 25, for example.

Therefore, for example, in the terminal device 32, the update of the privacy policy can be detected, and as shown by utterance T1 in FIG. 25, a user H can be notified that the privacy policy has been updated and what kind of changes are made, by voice such as “There is a change in the privacy policy. The policy publication date has been changed. Information to be used internally has been changed. Information to be used externally by Sony group company has been changed. Information to be used externally by a third-party contractor has been changed. Information to be used externally by the approved third party has been changed.”.

Furthermore, as shown by utterance T2 in FIG. 25, for example, in response to utterance such as “Tell me about the external use by AAA group company.” by the user who has heard this utterance T1, the terminal device 32 recognizes a command instructing presentation of detailed information, and the above-described policy detail displaying process is executed.

As a result, in response to this command, the terminal device 32 can present the detailed information by utterance T3 such as, for example, “The following information has been added. Measurement date and time. Five-stage evaluation of diet, immediately previous sleep, exercise, fatigue, and mood. Information about whether during menstruation.”.

Furthermore, since a dialog made between the user and the privacy policy agent device 31 via the terminal device 32 described above is to be stored in the dialog history storage unit 56 as a dialog history, the summary information generation unit 193 of the summary generation unit 54 can generate the summary information according to the dialog history.

That is, for example, in a case where, for a particular item, a dialog in which a command requesting display of detailed information is repeatedly issued remains in the dialog history storage unit 56, the summary information generation unit 193 may generate the summary information such that the item for which display of detailed information is repeatedly requested becomes conspicuous, for example, by bold characters, capital letters, and change of display colors so as to make more noticeable. By doing in this way, it becomes possible for the user to quickly find items that are always concerned.

Moreover, by accumulating consent or refusal for the privacy policy in the consent/refusal history storage unit 60 in association with the dialog, it becomes possible to leave an evidence regarding consent or refusal for the privacy policy.

Note that, in the above, an example for the purpose of assisting related to recognition and consent for the privacy policy has been described, but the present technology may also be applied to other than the privacy policy, and may be used in various contracts, for example, since it is only necessary that difficult sentences can be checked.

Furthermore, in the above, a description has been given to an example in which, when there is update (change) of the privacy policy, changed points in the privacy policy are emphasized and displayed, and different points between two different privacy policies are emphasized and presented, but difference items may be emphasized and displayed by performing other comparisons.

For example, a privacy policy may be compared and displayed for a service that has not been used. Furthermore, for a service already used, a privacy policy regarding a related service company may be compared and presented.

Furthermore, a privacy policy of a service already used and a privacy policy of a service that the user intends to use may be displayed so as to enable comparison.

In the above, an example of a privacy policy in Japanese has been described, but privacy policies of a service in Japan and a service in U.S. may be compared, for example.

That is, when a certain mail order service offers services in countries A and B, and a user can use both services, it is also possible to present and compare differences in a case where a content of the privacy policy of the service differs for every country due to a difference in the laws of the country A and the country B, or cooperation partners being different in every country on the service side, for example.

Furthermore, in comparison of multiple services, when a user refuses a privacy policy of Service A, it is also possible to propose another service whose privacy policy item matches a user's intention while focusing on the refused privacy policy item.

Moreover, in the above, the description has been made with the privacy policy as an example, but an insurance plan summary of life insurance, a comparison summary of multiple plans, interactive difference presentation of these, a difference in local regulations, a difference before/after law amendments, a difference in the same legal item for every country/region, and presentation of a privacy policy/terms of use may be added with other information to be presented.

Furthermore, it is also possible to present, for laws regarding privacy in the country where the user lives and the country where the service is provided, a summary obtained by: analysis of a word-of-mouth site that advises reputation on the WEB and a past case “This company has leaked privacy before”; construction of a database of the information by human power; or the like.

Moreover, for example, when a resident in Europe where the personal information protection law is strict uses a service of another country where the same law is less strict, advice may be given on a difference in the personal information protection laws between the two countries, in addition to comparison of privacy policies.

Furthermore, advice may be given on consent or refusal on the basis of a learning record of policy items consented/refused by the user in the past. Moreover, when the summary is presented, items of the privacy policy refused by the user in the past may be prominently presented. Furthermore, at a time of user's consent, if there is a content of the policy item refused by the user in another service, attention and confirmation may be prompted. For example, a confirmation may be prompted such as “Provision of location information to a third party has been refused in Service A, and Service B is similar. Would you still like to consent?”.

### 3. Second Embodiment

In the above, a description has been given to an example in which, when a privacy policy update is detected, a summary of a changed point in the privacy policy accompanying the update is presented in an easily recognizable manner. However, it is also possible to provide an imaging unit in a terminal device 32 to capture an image of a privacy policy that a user has as paper at hand, transmit to a privacy policy agent device 31, generate summary information to supply to the terminal device 32, and overlay and display a changed point on the image of the imaged privacy policy on an operation display unit 112 in an easily recognizable manner.

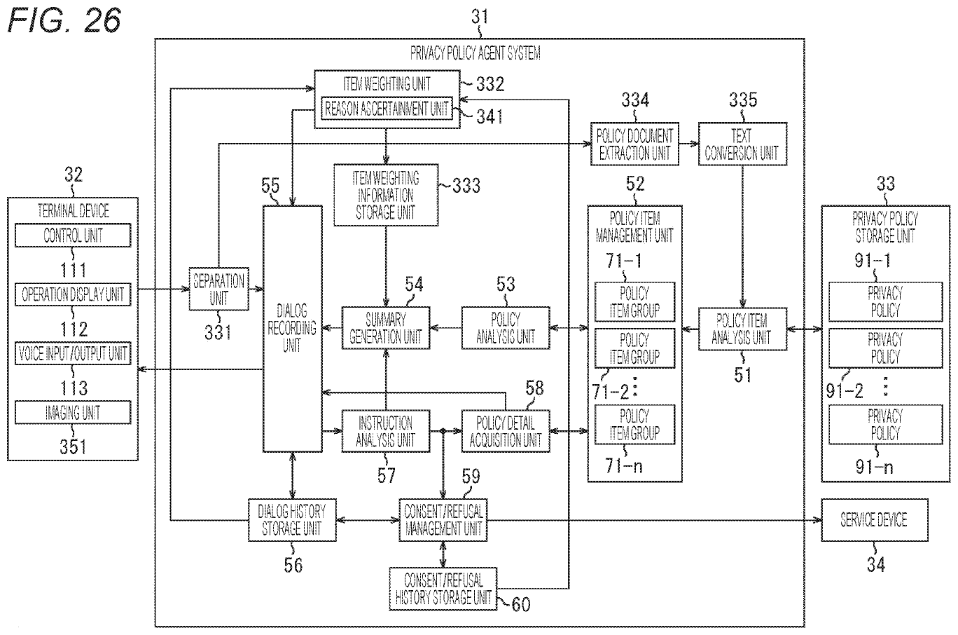

FIG. 26 shows a configuration example of the privacy policy agent device 31 and the terminal device 32, in which the terminal device 32 images the privacy policy on paper and transmits the imaged privacy policy to the privacy policy agent device 31, and the privacy policy agent device 31 generates summary information of the imaged privacy policy, further generates the summary information, and transmits to the terminal device 32. Then, on the basis of the summary information, the terminal device 32 performs overlay display of important points on the imaged privacy policy in an easily recognizable manner.

Note that, in the privacy policy agent device 31 and the terminal device 32 of FIG. 26, configurations having the same functions as those of the privacy policy agent device 31 and the terminal device 32 of FIG. 2 are denoted by the same reference numerals, and the description thereof will be omitted.

That is, in the privacy policy agent device 31 of FIG. 26, a point different from the privacy policy agent device 31 of FIG. 2 is that a separation unit 331, an item weighting unit 332, an item weighting information storage unit 333, a policy document extraction unit 334, and a text conversion unit 335 are newly provided.

The separation unit 331 separates an image in which the privacy policy is imaged and that is supplied from the terminal device 32, supplies to the policy document extraction unit 334, and outputs other data such as voice data and text to a dialog recording unit 55.

The item weighting unit 332 includes a reason ascertainment unit 341. In a case where a command regarding consent or refusal for the privacy policy is inputted, the item weighting unit 332 controls the reason ascertainment unit 341 to inquire of the terminal device 32 via the dialog recording unit 55 about a reason for consent or refusal for the privacy policy, sets a weight for every item in the policy item group on the basis of the response, and causes the item weighting information storage unit 333 to store as item weighting information.

The item weighting information storage unit 333 stores, not only weighting information for every item according to the reason for consent or refusal for the privacy policy, but also weighting information for every item according to a general importance in the privacy policy. For example, various kinds of weighting information such as a weight (monetary weight) for a total purchase amount, parental consent (age weight), female-only service (gender weight), or health information (highly confidential) are added.

Therefore, for example, since the total purchase amount is an item that anyone is generally concerned in purchasing a product, and thus has a relatively high importance for any user, the weighting information may be increased. Furthermore, in a case where the user is a minor, since the item of parental consent has high importance, the weighting information may be set to a relatively large value. Moreover, since the item regarding female-only service has higher importance for a female user, the weighting may be increased.

Furthermore, for a user having uneasiness about health due to an advanced age or the like, weighting information for increasing the importance of health information may be registered. Furthermore, without limiting to these, weighting information linked with information about dynamically changing stock price and exchange may be set. For example, in situations where extreme fluctuations in exchange rates are detected, items related to the exchange rate have high importance, and therefore the weighting information may be increased.

A summary generation unit 54 generates summary information in accordance with a weight set for the every these items such that the items with high importance and high weight are displayed more conspicuously.

The policy document extraction unit 334 extracts a region where the privacy policy is imaged from an image of the privacy policy supplied from the separation unit 331, and outputs to the text conversion unit 335.

The text conversion unit 335 includes, for example, an optical character recognition/reader (OCR) and the like, reads character information in a region where the privacy policy is imaged supplied from the policy document extraction unit 334, converts into text, and supplies to a policy item analysis unit 51.

The policy item analysis unit 51 analyzes the privacy policy imaged by the terminal device 32 for every item with a policy item analyzing process, generates a policy item group 71, and causes a policy item management unit 52 to store.

That is, by such processing, among the stored policy item groups 71 of the privacy policy, the policy item management unit 52 searches for and reads out the policy item group 71 of the privacy policy imaged by the terminal device 32, and outputs to a policy analysis unit 53.

For the read policy item group 71 of the privacy policy imaged by the terminal device 32, the policy analysis unit 53 generates difference information including a common item and a difference item with a policy analyzing process, and outputs to the summary generation unit 54.

The summary generation unit 54 generates summary information as described above, and at that time, generates summary information for conspicuously displaying items with high importance on the basis of weighting information for the various items stored in the item weighting information storage unit 333, and outputs to the terminal device 32 via the dialog recording unit 55.

On the basis of the summary information supplied from the privacy policy agent device 31, the terminal device 32 realizes overlay display and causes the operation display unit 112 to display so that information with high importance is displayed conspicuously on a displayed image of the imaged privacy policy on the basis of the summary information.

<Configuration Example of Instruction Analysis Unit of FIG. 26>

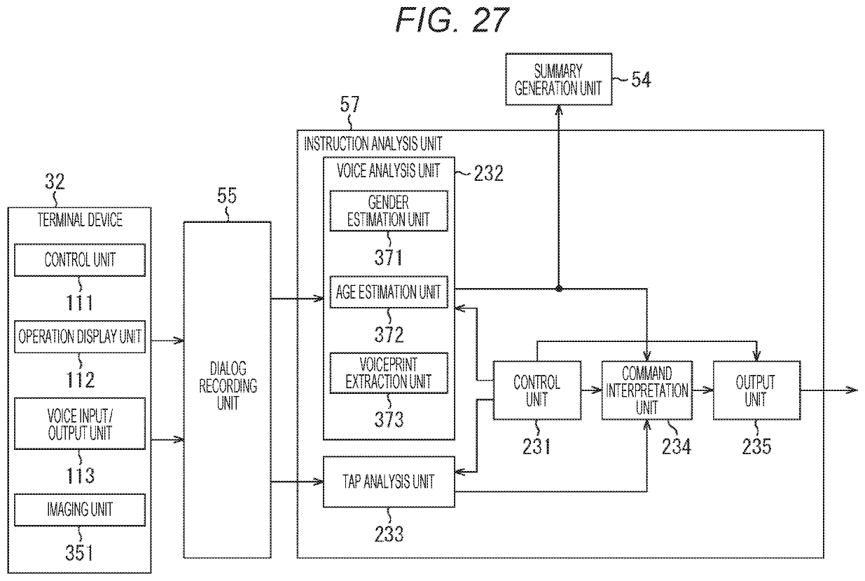

Next, a configuration example of an instruction analysis unit 57 of FIG. 26 will be described with reference to a block diagram of FIG. 27. Note that, in the configuration of the instruction analysis unit 57 in FIG. 27, configurations having the same functions as the configuration of the instruction analysis unit 57 in FIG. 10 are denoted by the same reference numerals, and the description thereof will be omitted as appropriate.

That is, the instruction analysis unit 57 in FIG. 27 differs in that a voice analysis unit 232 includes a gender estimation unit 371, an age estimation unit 372, and a voiceprint extraction unit 373.

The gender estimation unit 371 estimates gender on the basis of voice data of user's utterance supplied from the terminal device 32, and outputs an estimation result to the summary generation unit 54.

The age estimation unit 372 estimates age on the basis of voice data of user's utterance supplied from the terminal device 32, and outputs an estimation result to the summary generation unit 54.

The voiceprint extraction unit 373 extracts a voiceprint on the basis of voice data of user's utterance supplied from the terminal device 32, and outputs an extraction result to a consent/refusal management unit 59, via a command interpretation unit 234 and an output unit 235. When a command regarding consent or refusal for the privacy policy is transmitted, the consent/refusal management unit 59 causes a consent/refusal history storage unit 60 to store dialog information and voiceprint information as an evidence for the consent or refusal.

<Configuration Example of Summary Generation Unit of FIG. 26>

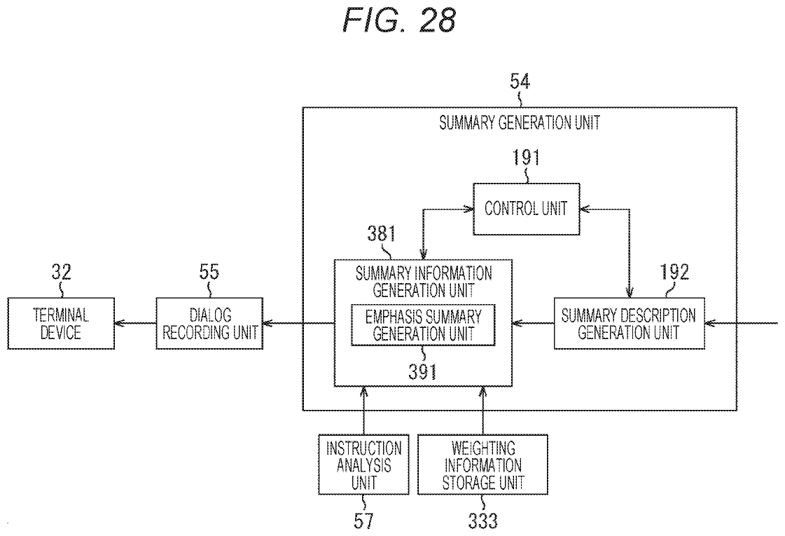

Next, a configuration example of the summary generation unit 54 of FIG. 26 will be described with reference to a block diagram of FIG. 28. Note that, in the configuration of the summary generation unit 54 in FIG. 28, configurations having the same functions as the configuration of the summary generation unit 54 in FIG. 9 are denoted by the same reference numerals, and the description thereof will be omitted as appropriate.

That is, in the configuration of the summary generation unit 54 in FIG. 28, a point different from the summary generation unit 54 in FIG. 9 is that a summary information generation unit 381 is provided instead of the summary information generation unit 193. In displaying a summary of a privacy policy on the operation display unit 112 of the terminal device 32, the summary information generation unit 381 generates summary information for emphasis display in accordance with importance of every item that is individually different for users in the privacy policies summarized and displayed, on the basis of an age estimation result and a gender estimation result supplied from the instruction analysis unit 57, and weighting information stored in the item weighting information storage unit 333.

More specifically, the summary information generation unit 381 includes an emphasis summary generation unit 391, sets importance for every item unique to the user on the basis of the gender estimation result, the age estimation result, and the weighting information, and generates a summary image for emphasis display of information of high importance. For example, in a case where the gender estimation result is male, the age estimation result is twenties, and detail display for a purchase history is repeatedly requested as the weighting information, the emphasis summary generation unit 391 generates summary information in which items specific to male, items specific to twenties, and internal use and external provision of information regarding the purchase history are regarded as information with high importance by setting a large weight, and are emphasized and displayed, for example, by displaying individual corresponding items in a large size or by changing colors when the summary description is displayed.

<Weighting Process>

Next, a weighting process will be described with reference to a flowchart of FIG. 28.

In step S151, the item weighting unit 332 determines whether or not a command regarding consent or refusal for the privacy policy has been supplied from the terminal device 32 via the dialog recording unit 55. In step S151, in a case where the command regarding consent or refusal for the privacy policy has been transmitted from the terminal device 32, the process proceeds to step S152.

In step S152, the item weighting unit 332 controls the reason ascertainment unit 341 to inquire of the terminal device 32 via the dialog recording unit 55 about a reason for the consent or refusal for the privacy policy, generates weighting information for a corresponding item, on the basis of a response, and causes the item weighting information storage unit 333 to store.

That is, when the reason ascertainment unit 341 supplies information for inquiring about the reason for the consent or refusal for the privacy policy to the terminal device 32 via the dialog recording unit 55, the control unit 111 of the terminal device 32 controls the operation display unit 112 to display a display image inquiring about the reason for the consent or refusal for the privacy policy, or controls the voice input/output unit 113 to output voice for inquiring about the reason for the consent or refusal for the privacy policy.

In response to this processing, when the user operates the operation display unit 112 to input an answer of the reason, or when the voice input/output unit 113 inputs an answer uttered by the user, answer information is supplied from the terminal device 32 to the reason ascertainment unit 341 of the privacy policy agent device 31 via the dialog recording unit 55. On the basis of the information of the reason for the consent or refusal for the privacy policy, a weighting unit 322 generates weighting information for the corresponding item, and causes the item weighting information storage unit 333 to store.

In step S153, the item weighting unit 332 determines whether or not termination of the weighting process has been instructed. In a case where termination is not instructed, the process returns to step S151 and the subsequent processes are repeated. Then, in step S153, when termination is instructed, the weighting process is terminated.

That is, by the above processing, every time the command regarding consent or refusal is supplied, the reason is inquired to the user, and weighting information corresponding to the response is generated and stored in the item weighting information storage unit 333.

For example, in a case where a command indicating consent for a privacy policy related to service provision of the C mail order is detected, the reason ascertainment unit 341 sends an inquiry such as “What is the reason for the consent for the privacy policy regarding the service provision of C mail order?”. In response to this, by obtaining an answer such as “Because the purchase statistics are for the whole” is obtained when the user operates the operation display unit 112 of the terminal device 32, and giving a weight to the point that the purchase statistics are for the whole and performing emphasis display for purchase statistics for the whole in the future, it becomes possible for the user to promptly recognize information that has been a decision factor of consent.

Furthermore, since it is possible to recognize that the user is aware of the purchase statistics, further, the reason ascertainment unit 341 may further send an inquiry such as “Would you not externally provide the purchase statistics in the service provision in B mail order?”. In response to this, it is considered that the operation display unit 112 of the terminal device 32 is operated, an answer such as “I have quit B mail order service for a reason other than the privacy policy” is obtained. In this case, the item weighting information storage unit 333 may set a weight to the minimum for information of items of the purchase statistics related to the B mail order so as not to consider thereafter.

<Privacy Policy Agent Process by Privacy Policy Agent Device of FIG. 26>

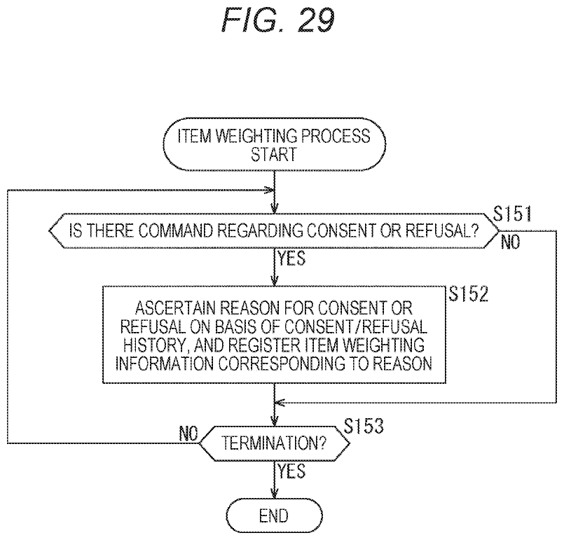

Next, a privacy policy agent process by the privacy policy agent device 31 of FIG. 26 will be described with reference to a flowchart of FIG. 29.

In step S171, in response to an operation of the user, an imaging unit 351 of the terminal device 32 images the privacy policy printed on paper for which a summary is desired to be presented, and generates an image.

In step S172, when a command is inputted as voice by user's utterance to the voice input/output unit 113 of the terminal device 32 to request a summary display of the imaged privacy policy, the control unit 111 transmits voice data including the command and the image in which the privacy policy is imaged, to the privacy policy agent device 31.

In step S173, the separation unit 331 separates the image in which the privacy policy is imaged and other information, outputs the image in which the privacy policy is imaged to the policy document extraction unit 334, and outputs information including the voice data and requesting presentation of a summary of the privacy policy, to the instruction analysis unit 57.

In step S174, the gender estimation unit 371 of the voice analysis unit 232 estimates gender of the user who has requested the presentation of the summary on the basis of the voice data, and outputs to the summary generation unit 54.

In step S175, the age estimation unit 372 of the voice analysis unit 232 estimates age of the user who has requested the presentation of the summary on the basis of the voice data, and outputs to the summary generation unit 54.

In step S176, the voiceprint extraction unit 373 of the voice analysis unit 232 extracts a voiceprint of the user who has requested the presentation of the summary on the basis of the voice data, supplies to the consent/refusal management unit 59, and causes the consent/refusal history storage unit 60 to store as an evidence for the consent or refusal for the privacy policy.

In step S177, the policy document extraction unit 334 extracts a region where the privacy policy is imaged in the image in which the privacy policy is imaged, and outputs to the text conversion unit 335.

In step S178, the text conversion unit 335 analyzes, by the OCR, the region where the privacy policy is imaged, performs conversion into text data, and outputs to the policy item analysis unit 51.

In step S179, the policy item analysis unit 51 executes the policy item analyzing process to analyze an item, and causes the policy item group storage unit 151 of the policy item management unit 52 to store the policy item group 71 that is an analysis result. Note that the policy item analyzing process is the process described with reference to the flowchart of FIG. 13, and therefore the description thereof will be omitted.

In step S180, the policy item management unit 52 executes a policy item searching process, to search for and extract the policy item groups 71 of the privacy policy imaged by the imaging unit 351 and of a related privacy policy of the privacy policy, and supply to the policy analysis unit 53. Note that the policy item searching process is the process described with reference to the flowchart of FIG. 15, and therefore the description thereof will be omitted. Furthermore, the related privacy policy is a privacy policy that serves as a reference for determining consent or refusal for the privacy policy imaged by the imaging unit 351, such as, for example, an old version privacy policy of the same service in the past, a privacy policy regarding a service of the same operating company, or the like.

In step S181, the policy analysis unit 53 executes the policy analyzing process, to generate difference information including a common item and a difference item for every item, and output to the summary generation unit 54. Note that, in step S180, in a case where there is no privacy policy that serves as a reference for determining consent or refusal for the privacy policy imaged by the imaging unit 351, and there is only the privacy policy imaged by the imaging unit 351, the policy analysis unit 53 may output, as difference information, only information of the policy item group of the privacy policy imaged by the imaging unit 351 to the summary generation unit 54.

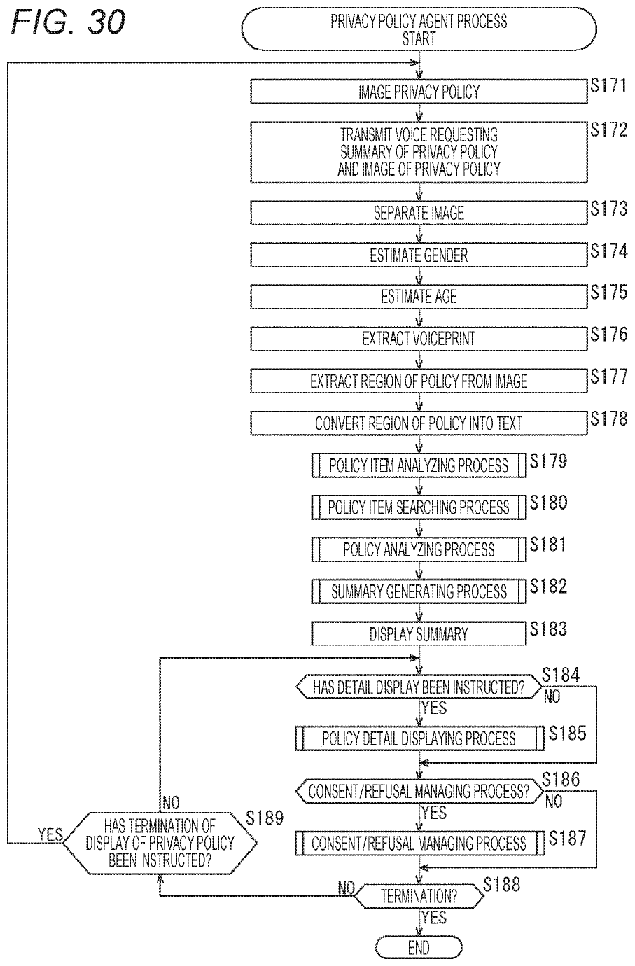

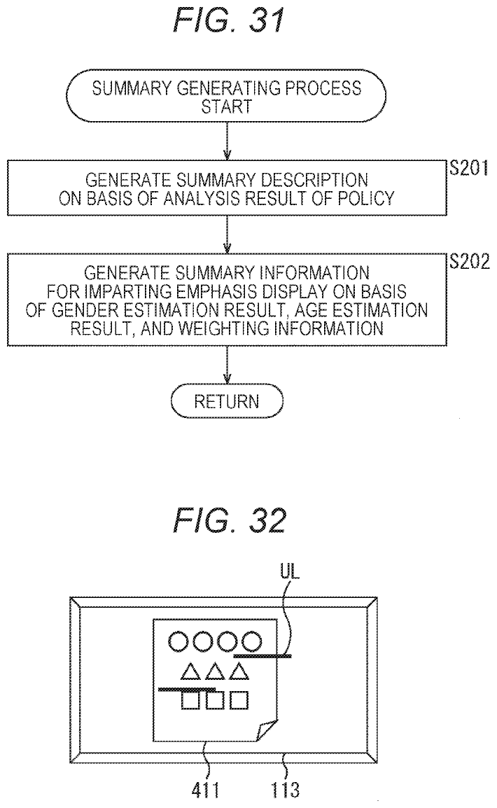

In step S182, the summary generation unit 54 executes a summary generating process, to generate summary information on the basis of the difference information, on the basis of a gender estimation result and an age estimation result of the user and weighting information stored in the item weighting information storage unit 333, and outputs to the terminal device 32 via the dialog recording unit 55. Note that the summary generating process will be described later in detail with reference to a flowchart of FIG. 30.

In step S183, on the basis of the supplied summary information, the control unit 111 of the terminal device 32 displays the summary so as to emphasize in accordance with the weight of the items according to the gender estimation result and the age estimation result of the user, weighting information, and the like, in a format of overlaying on the imaged privacy policy image on the operation display unit 112.

Note that the processing in steps S184 to S189 is similar to the processing in steps S36 to 41 in the flowchart of FIG. 14, and therefore a description thereof will be omitted.

<Summary Generating Process in Privacy Policy Agent Device of FIG. 26>

Next, the summary generating process in the privacy policy agent device 31 of FIG. 26 will be described with reference to a flowchart of FIG. 30.

In step S201, the summary description generation unit 192 of the summary generation unit 54 generates a summary description on the basis of the difference information supplied from the policy analysis unit 53, and outputs to the summary information generation unit 381.

In step S202, the summary information generation unit 381 controls the emphasis summary generation unit 391, sets importance for every item unique to the user on the basis of a gender estimation result, an age estimation result, and weighting information, generates summary information for emphasis display of important information, and outputs to the terminal device 32 via the dialog recording unit 55.

By the above processing, emphasis summary information in accordance with importance of every item unique to the user is generated on the basis of the gender estimation result, the age estimation result, and the weighting information, and, for example, as shown in FIG. 32, it becomes possible to display, on the operation display unit 112, such an emphasized image in which an underline UL is overlaid and displayed for a part with high importance in a region 411 of the privacy policy on the image captured by the imaging unit 351.

Furthermore, since emphasizing is only required, for example, summary information such as for reading out important items of the privacy policy by voice may be generated, and outputted as voice from the voice input/output unit 113 of the terminal device 32. In this case, for a portion to be emphasized, at the time of reading aloud, intonation, timbre, and volume may be changed in accordance with magnitude of a weight for emphasizing.

As a result, by simply capturing an image of the privacy policy on the paper with the imaging unit 351 and looking at the captured image, the user can quickly and accurately recognize important information in the privacy policy, through emphasis display on the image according to the importance of every item for the user.

Furthermore, in the above, an example has been described in which the present technology is realized by the user carrying the terminal device 32 and exchanging various data with the privacy policy agent device 31. However, for example, the present technology may be applied to a spectacles-type wearable terminal and the like, and, by using a wearable terminal equipped with a transmissive display and a camera, items with high importance may be emphasized and displayed by augmented reality (AR) display in the transmissive display, on an actual privacy policy viewed and listened by the user through spectacles.

Moreover, the age and gender may be estimated not only from the voice but also from application software being used, for example. For example, in a case of the terminal device 32 installed with application software for managing a menstrual cycle, since it can be estimated to be female with high probability, gender may be estimated in accordance with the application software being used.

Furthermore, in a case where it can be known that the user is a child on the basis of the age estimation result, pronunciation may be provided in kana for written description, or, in a case of voice, voice may be spoken slowly and gently by a female voice.

Moreover, when it can be estimated that the user is a child, for items related to money, consent or refusal may be disabled, or speech for encouraging consultation with the parental authority may be made.

Furthermore, when it can be estimated by voice that the user is a child, description of a service with age restriction may be disabled. Furthermore, in a case where it is estimated to be male by voice, consent for female-only service may be disabled.

Moreover, the age and gender may be estimated not only from the voice, but also from, for example, a captured image.

### 4. Third Embodiment

In the above, a description has been given to an example of presenting a summary of a changed point in a privacy policy accompanying update of the privacy policy in an easily recognizable manner, or overlaying and displaying a changed point on the image of the imaged privacy policy on the operation display unit 112 in an easily recognizable manner.

In any of the above, an example has been described in which a user determines consent or refusal for the privacy policy, but a privacy policy agent device 31 may make the determination on the basis of information regarding consent or refusal registered in advance or a history.

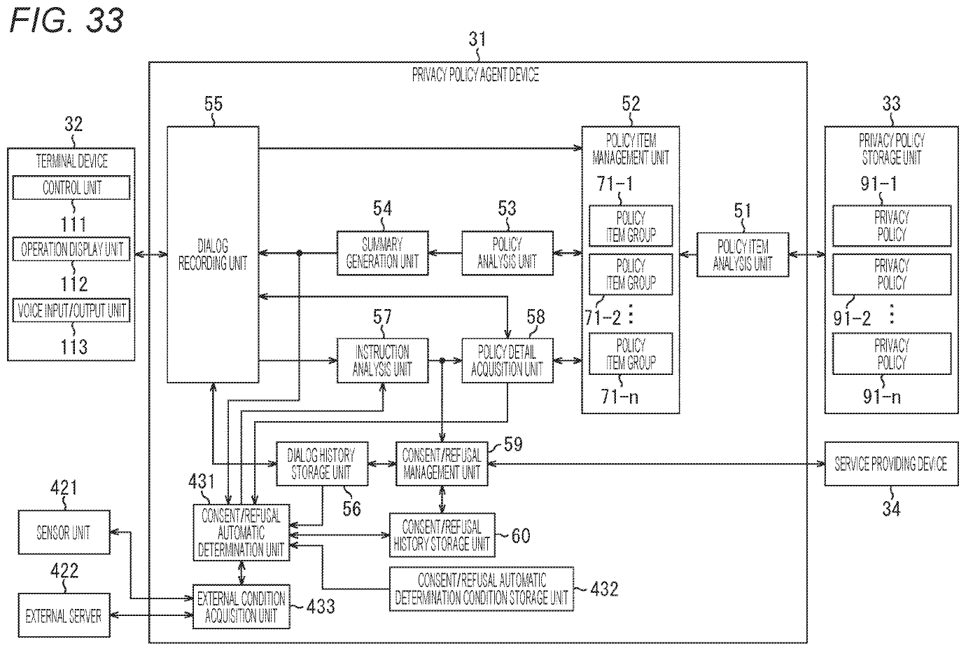

FIG. 33 shows a configuration example of the privacy policy agent device 31 adapted to make determination for consent or refusal for a privacy policy on the basis of information regarding consent or refusal registered in advance or a history, without intervention of a user.

Note that, in the privacy policy agent device 31 of FIG. 33, a point different from the privacy policy agent device 31 of FIG. 2 is that a sensor unit 421 and an external server 422 are connected, and a consent/refusal automatic determination unit 431, a consent/refusal automatic determination condition storage unit 432, and an external condition acquisition unit 433 are provided.

The sensor unit 421 includes a sensor configured to detect information that is an external condition required for determination of consent or refusal for the privacy policy, and outputs a detection result to the external condition acquisition unit 433. For example, in a case where the external condition is a condition related to a time of day and the like, the sensor unit 421 is a real-time clock or the like that generates time information. In a case where brightness, temperature, and the like are external conditions, the sensor unit 421 includes an illuminance meter, a thermometer, and the like. That is, the sensor unit 421 is configured by a detector for information corresponding to an item set as an external condition. Note that a specific configuration of the sensor unit 421 is not limited to the real-time clock, the illuminance meter, and the thermometer described above, any configuration may be adopted as long as information that can be set as an external condition is detected.

The external server 422 is, for example, a server connected via a network 35 in FIG. 1, and is a server that provides an external condition required for determination of consent or refusal for a privacy policy. For example, in a case where a fluctuating stock price or the like is set as the external condition, the external server 422 is a server that provides information about the stock price.

The consent/refusal automatic determination unit 431 executes a process of acting on behalf of a user in a consent/refusal managing process in which the user operates a terminal device 32 while checking a summary of a privacy policy, and inputs consent or refusal.

More specifically, when acquiring information of a summary of a privacy policy supplied from a summary generation unit 54, the consent/refusal automatic determination unit 431 reads out a consent/refusal automatic determination condition stored in advance in the consent/refusal automatic determination condition storage unit 432, and determines consent or refusal for the privacy policy on the basis of whether or not there is a match.

At this time, the consent/refusal automatic determination unit 431 acquires details of the privacy policy from a policy detail acquisition unit 58 as necessary, and determines consent or refusal for the privacy policy on the basis of whether or not there is a match between with the consent/refusal automatic determination condition.

Furthermore, while also using information of a dialog history and a consent/refusal history stored in a dialog history storage unit 56 and a consent/refusal history storage unit 60, if necessary, the consent/refusal automatic determination unit 431 determines consent or refusal for the privacy policy on the basis of whether or not there is a match between with the consent/refusal automatic determination condition.

Moreover, also with information about the external condition supplied from the external condition acquisition unit 433, if necessary, the consent/refusal automatic determination unit 431 determines consent or refusal for the privacy policy on the basis of whether or not there is a match between with the consent/refusal automatic determination condition.

The consent/refusal automatic determination unit 431 supplies a determination result of the consent or refusal for the privacy policy as text information indicating the consent or refusal or text information requesting policy details to, for example, a command interpretation unit 234 of an instruction analysis unit 57 shown in FIG. 10.

The command interpretation unit 234 interprets a command on the basis of the text information from the consent/refusal automatic determination unit 431, and outputs to an output unit 235. More specifically, when an interpretation result of the command is a policy detail acquisition command, the output unit 235 outputs to the policy detail acquisition unit 58. Furthermore, when the interpretation result of the command is a command indicating consent or refusal, the output unit 235 outputs to the consent/refusal management unit 59.

<Privacy Policy Agent Process by Privacy Policy Agent Device 31 of FIG. 33>

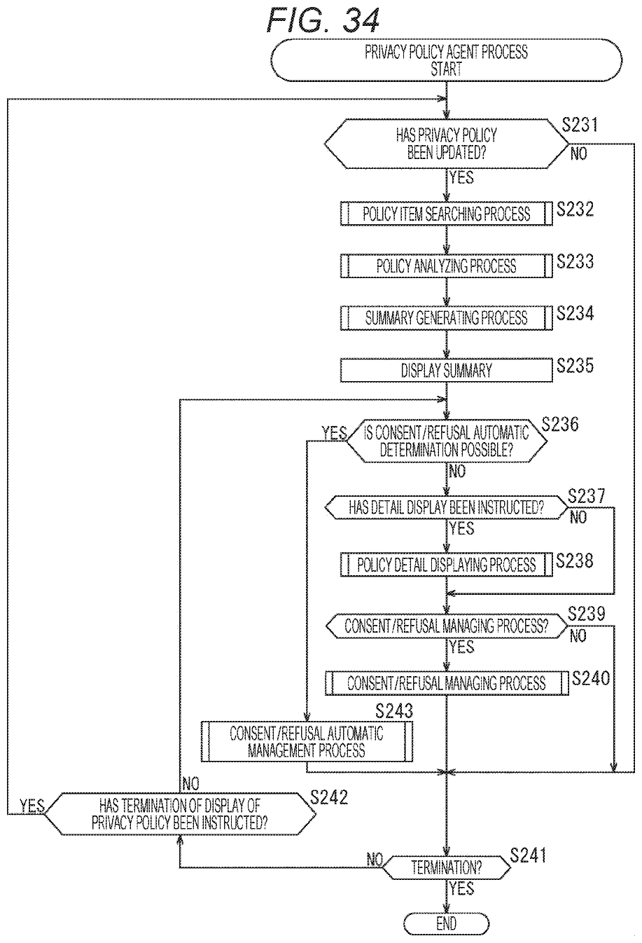

Next, a privacy policy agent process by the privacy policy agent device 31 of FIG. 33 will be described with reference to a flowchart of FIG. 34.

Note that the privacy policy agent process in FIG. 34 is on the premise that a policy item group 71 is stored in a policy item management unit 52 by the policy item analyzing process described with reference to the flowchart of FIG. 13. Furthermore, the processing of steps S231 to S235 and the processing of steps S237 to S242 in the flowchart of FIG. 34 are similar to the processing of steps S31 to S41 in the flowchart of FIG. 14, and therefore a description thereof is omitted.

That is, when a summary of a privacy policy is displayed by the processing of steps S231 to S235, the summary of the privacy policy is supplied to the consent/refusal automatic determination unit 431.

In step S236, the consent/refusal automatic determination unit 431 accesses the consent/refusal automatic determination condition storage unit 432, and determines whether or not automatic determination for consent or refusal is possible, on the basis of whether or not a consent/refusal automatic determination condition corresponding to the supplied summary of the privacy policy is stored.

In step S236, in a case where it is determined that the consent/refusal automatic determination condition corresponding to the summary of the privacy policy is not stored, the automatic determination is regarded to be impossible, and the process proceeds to step S237. That is, in this case, the automatic determination process is not performed, and the determination is made by the user as described above.

Whereas, in step S236, in a case where the consent/refusal automatic determination condition corresponding to the summary of the privacy policy is stored, the automatic determination is regarded to be possible, and the process proceeds to step S243.

In step S243, the consent/refusal automatic determination unit 431 executes a consent/refusal automatic management process, to determine consent or refusal for the privacy policy corresponding to the supplied summary of the privacy policy, cause the consent/refusal history storage unit 60 to store a determination result, and output the determination result to a service providing device.

<Consent/Refusal Automatic Management Process>

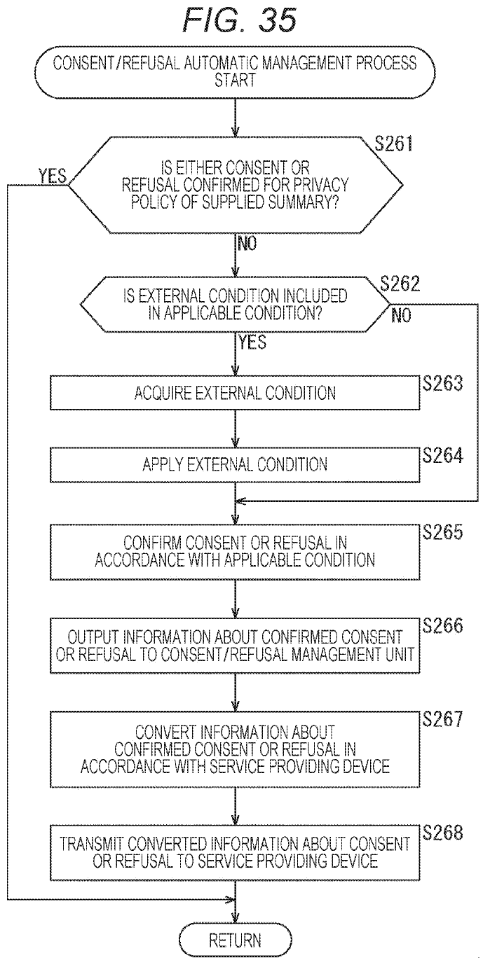

Here, the consent/refusal automatic management process will be described with reference to a flowchart of FIG. 35.

In step S261, the consent/refusal automatic determination unit 431 accesses the consent/refusal history storage unit 60, and determines whether or not either consent or refusal for the supplied privacy policy is confirmed.

In step S261, in a case where it is determined that either consent or refusal for the privacy policy of the supplied summary is confirmed, the consent/refusal automatic management process is terminated since the processing has already been performed.

Furthermore, in step S261, in a case where it is determined that neither consent nor refusal for the privacy policy of the supplied summary is confirmed, the process proceeds to step S262. That is, for the supplied privacy policy, the determination related to consent or refusal has not been processed, and therefore the processing is continued.

In step S262, the consent/refusal automatic determination unit 431 determines whether or not an external condition is included in the consent/refusal automatic determination condition for determining consent or refusal for the privacy policy of the supplied summary.

In step S262, in a case where an external condition is included in the consent/refusal automatic determination condition for determining consent or refusal for the privacy policy of the supplied summary, the process proceeds to step S263.

In step S263, the consent/refusal automatic determination unit 431 controls the external condition acquisition unit 433, to access the sensor unit 421 and the external server 422 to acquire a necessary external condition.

In step S264, the consent/refusal automatic determination unit 431 applies the external condition to the consent/refusal automatic determination condition for determining consent or refusal for the privacy policy of the supplied summary for which the external condition that has been acquired by the external condition acquisition unit 433 is acquired.

Note that, in a case where the external condition is not included in the consent/refusal automatic determination condition in step S262, the processing in steps S263 and S264 is skipped.

In step S265, by comparing the privacy policy of the supplied summary and the corresponding consent/refusal automatic determination condition, the consent/refusal automatic determination unit 431 determines either consent or refusal in accordance with the applicable condition, and causes confirmation of the determination result. At this time, the consent/refusal automatic determination unit 431 controls the policy detail acquisition unit 58 via the instruction analysis unit 57 to acquire policy detail information. More specifically, the consent/refusal automatic determination unit 431 outputs the policy detail acquisition command including text information to the command interpretation unit 234 of the instruction analysis unit 57. The command interpretation unit 234 interprets the command, and causes the output unit 235 to output the policy detail acquisition command to the policy detail acquisition unit 58 on the basis of the interpretation result. Therefore, the consent/refusal automatic determination unit 431 acquires the policy detail information from the policy detail acquisition unit 58. Furthermore, by also using a consent/refusal history of the consent/refusal history storage unit 60 and dialog history information stored in the dialog history storage unit 56, the consent/refusal automatic determination unit 431 determines whether consent or refusal by comparing with the corresponding consent/refusal automatic determination condition, and causes confirmation of the determination result.

In step S266, the consent/refusal automatic determination unit 431 outputs the determination result of consent or refusal confirmed for the privacy policy of the supplied summary, to the consent/refusal management unit 59. More specifically, the consent/refusal automatic determination unit 431 outputs a command indicating consent or refusal to the command interpretation unit 234 of the instruction analysis unit 57. The command interpretation unit 234 interprets the command, and outputs information about consent or permission, which is the interpretation result, to the consent/refusal management unit 59.

In step S267, the control unit 291 of the consent/refusal management unit 59 outputs information about consent or refusal for the privacy policy to a consent/refusal notification unit 292. The consent/refusal notification unit 292 converts the information about consent or refusal for the privacy policy in accordance with a communication format of the service providing device 34 of the privacy policy, which is to be a transmission destination.

More specifically, in accordance with the communication form of the service providing device 34 that provides a service corresponding to the privacy policy and is to be the transmission destination, the consent/refusal notification unit 292 selects and causes either communication format conversion units 311-1 to 311-n or a standardized communication format conversion unit 312 to convert the communication format.

In step S268, the consent/refusal notification unit 292 transmits information that is about consent or refusal for the privacy policy and has been converted into the appropriate communication format, to the service providing device 34.

By this processing, it is possible to appropriately notify the service providing device 34 in various communication formats, of information about consent or refusal for the privacy policy.

By the above processing, when a privacy policy is updated, in addition to presenting updated contents to be easily viewable, it becomes possible to manage consent or refusal for the privacy policy without intervention of user operation processing. Furthermore, in a case where the automatic determination is regarded to be impossible, it is possible to manage consent or refusal for the privacy policy by the normal user operation processing described above. Moreover, by adding a consent/refusal automatic determination condition to the consent/refusal automatic determination condition storage unit 432, it becomes possible to increase the conditions on which the automatic determination is possible.

### 5. Example of Execution by Software

Meanwhile, a series of processes described above can be executed by hardware or also executed by software. In a case where the series of processes are executed by software, programs included in the software are installed from a storage medium to a computer built in dedicated hardware or, for example, a general-purpose computer and the like capable of executing various functions by installing various programs.

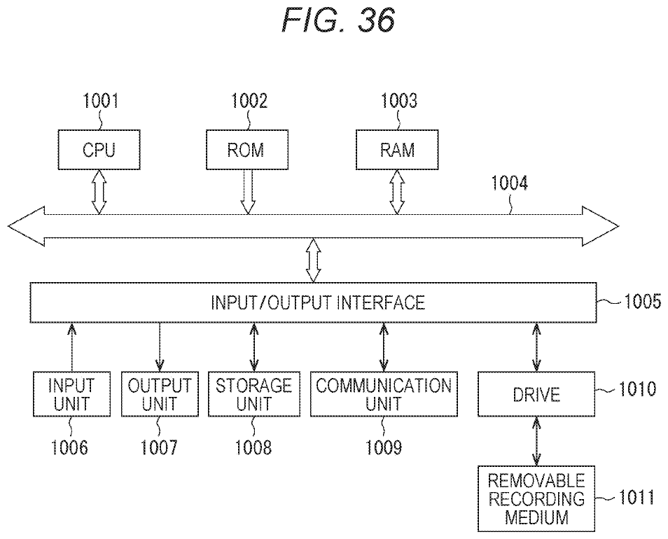

FIG. 36 illustrates a configuration example of a general-purpose computer. This personal computer incorporates a central processing unit (CPU) 1001. To the CPU 1001, an input/output interface 1005 is connected via a bus 1004. To the bus 1004, a read only memory (ROM) 1002 and a random access memory (RAM) 1003 are connected.

The input/output interface 1005 is connected with an input unit 1006 including an input device such as a keyboard and a mouse to be inputted with an operation command by a user, an output unit 1007 that outputs a processing operation screen or an image of a processing result to a display device, a storage unit 1008 including, for example, a hard disk drive that stores programs and various data, and a communication unit 1009 that includes a local area network (LAN) adapter and the like and executes communication processing via a network represented by the Internet. Furthermore, there is connected a drive 1010 that reads and writes data from and to a removable recording medium 1011 such as a magnetic disk (including a flexible disk), an optical disk (including a compact disc-read only memory (CD-ROM) and a digital versatile disc (DVD)), a magneto-optical disk (including a Mini Disc (MD)), or a semiconductor memory.

The CPU 1001 executes various processes in accordance with a program stored in the ROM 1002, or a program read from the removable recording medium 1011 such as a magnetic disk, an optical disk, a magneto-optical disk, or semiconductor memory, installed in the storage unit 1008, and loaded from the storage unit 1008 into the RAM 1003. The RAM 1003 also appropriately stores, for example, data necessary for the CPU 1001 to execute various processes.

In the computer configured as described above, the series of processes described above are performed, for example, by the CPU 1001 loading the program recorded in the storage unit 1008, into the RAM 1003 via the input/output interface 1005 and the bus 1004, and executing.

The program executed by the computer (the CPU 1001) can be provided by being recorded on, for example, the removable recording medium 1011 as a package medium or the like. Furthermore, the program can be provided via a wired or wireless transmission medium such as a local area network, the Internet, or digital satellite broadcasting.

In the computer, by attaching the removable recording medium 1011 to the drive 1010, the program can be installed in the storage unit 1008 via the input/output interface 1005. Furthermore, the program can be received by the communication unit 1009 via a wired or wireless transmission medium, and installed in the storage unit 1008. Besides, the program can be installed in advance in the ROM 1002 and the storage unit 1008.

Note that the program executed by the computer may be a program that performs processing in a chronological order according to the order described in this specification, or may be a program that performs processing in parallel or at necessary timing such as when a call is made.

Note that the CPU 1001 in FIG. 36 realizes the function of the privacy policy agent device 31 in FIGS. 2 and 26.

Furthermore, in this specification, the system means a set of a plurality of components (a device, a module (a part), and the like), and it does not matter whether or not all the components are in the same housing. Therefore, a plurality of devices housed in separate housings and connected via a network, and a single device with a plurality of modules housed in one housing are all systems.

Note that the embodiments of the present disclosure are not limited to the above-described embodiments, and various modified examples can be made without departing from the scope of the present disclosure.

For example, the present disclosure can have a cloud computing configuration in which one function is shared and processed in cooperation by a plurality of devices via a network

Furthermore, each step described in the above-described flowchart can be executed by one device, and also shared and executed by a plurality of devices.

Moreover, in a case where one step includes a plurality of processes, the plurality of processes included in the one step can be executed by one device, and also shared and executed by a plurality of devices.

Note that the present disclosure can also have the following configurations.

<1> An information processing apparatus including:

an analysis unit configured to analyze an item of a service agreement; and

a summary generation unit configured to generate a summary of a service agreement on the basis of an analysis result by the analysis unit.

<2> The information processing apparatus according to <1>, further including:

a service agreement item analysis unit configured to analyze an item of the service agreement, list a content for every item, and generate a service agreement item group for every the service agreement; and

a service agreement item management unit configured to store and manage the service agreement item group that is for every the service agreement and is generated by the service agreement item analysis unit.

<3> The information processing apparatus according to <1> or <2>, in which

the analysis unit generates, as an analysis result, difference information including a common item and a difference item in a same item of a plurality of service agreements.

<4> The information processing apparatus according to <3>, in which

the summary generation unit generates the summary for emphasis display of a difference item in the difference information, on the basis of an analysis result including the difference information.

<5> The information processing apparatus according to <3>, further including:

a summary description generation unit configured to generate a summary description on the basis of an analysis result including the difference information, in which

the summary generation unit processes and generates the summary description in accordance with a terminal device operated by a user to whom the summary is presented.

<6> The information processing apparatus according to <5>, in which

in a case where the terminal device has a display unit smaller than a first area, the summary generation unit generates a summary by processing the summary description into a simple list, supplies in response to a request from the terminal device, and causes the display unit to display.

<7> The information processing apparatus according to <6>, further including:

a detailed information generation unit, in which, in a case where the summary is obtained by processing the summary description into a simple list, when an item processed into the simple list is selected, the detailed information generation unit generates detailed information of the selected item, supplies in response to a request from the terminal device, and causes display.

<8> The information processing apparatus according to <6>, in which

in a case where the terminal device has a display unit smaller than a second area that is further smaller than the first area, the summary generation unit iconifies the summary description to generate a summary.

<9> The information processing apparatus according to <5>, in which

in a case where the terminal device has a voice output unit configured to output voice, the summary generation unit generates a summary by processing the summary description into voice data.

<10> The information processing apparatus according to <9>, in which

the summary generation unit generates a summary by processing, into voice data, the summary description for emphasis of a difference item in the difference information by voice, on the basis of an analysis result including the difference information.

<11> The information processing apparatus according to <6>, further including:

a service agreement item analysis unit configured to analyze an item of the service agreement, list a content for every item, and generate a service agreement item group for every the service agreement, in which

in a case where the terminal device has a display unit larger than a predetermined area, the summary generation unit uses information of the service agreement item group as it is, and generates a summary for emphasis display of information of the difference item.

<12> The information processing apparatus according to <2>, further including:

a consent/refusal management unit configured to accept and manage consent or refusal of a user for the service agreement;

a reason ascertainment unit configured to ascertain a reason for the consent or refusal; and

a weighting unit configured to weight every item in the service agreement item group in accordance with a reason ascertained by the reason ascertainment unit, in which

the summary generation unit adjusts emphasis display for the every item to generate a summary, in accordance with a weight weighted by the weighting unit.

<13> The information processing apparatus according to <12>, further including:

a consent/refusal determination unit configured to determine consent or refusal for the service agreement on the basis of a summary of the service agreement and a consent/refusal determination condition stored in advance, in which

the consent/refusal management unit accepts and manages consent or refusal determined by the consent/refusal determination unit for the service agreement.

<14> The information processing apparatus according to <12>, in which

the consent/refusal management unit accepts and manages consent or refusal of a user for the service agreement.

<15> The information processing apparatus according to <14>, further including:

a gender estimation unit configured to estimate gender on the basis of voice uttered by the user; and

an age estimation unit configured to estimate age on the basis of voice uttered by the user, in which

the summary generation unit adjusts emphasis display for the every item to generate a summary, on the basis of a weight weighted by the weighting unit, gender estimated by the gender estimation unit, and age estimated by the age estimation unit.

<16> The information processing apparatus according to <14>, further including:

a text conversion unit configured to convert a service agreement that is printed or displayed, into text from an image obtained by imaging a service agreement that is printed or displayed, in which

the analysis unit analyzes an item of the service agreement converted into text, and

the summary generation unit generates a summary for emphasis display, by overlaying and displaying on the imaged service agreement that is printed or displayed on the image for the every item, in accordance with a weight weighted by the weighting unit.

<17> The information processing apparatus according to <14>, in which

when accepting consent or refusal of a user for the service agreement, the consent/refusal management unit preforms conversion into a format receivable by each service providing device that provides a service corresponding to the service agreement, and notifies of information about the consent or refusal.

<18> The information processing apparatus according to <14>, further including:

a voiceprint extraction unit configured to extract a voiceprint on the basis of voice uttered by the user, in which,

when accepting consent or refusal of a user for the service agreement, the consent/refusal management unit stores the voiceprint in a predetermined storage unit in association with information about the consent or refusal.

<19> An information processing method including:

an analyzing process of analyzing an item of a service agreement; and

a summary generating process of generating a summary of a service agreement on the basis of an analysis result by the analyzing process.

<20> A program for causing a computer to function as:

an analysis unit configured to analyze an item of a service agreement; and

a summary generation unit configured to generate a summary of a service agreement on the basis of an analysis result by the analysis unit.

### REFERENCE SIGNS LIST

11 Privacy policy agent system
31 Privacy policy agent device
32, 32-1 to 32-n Terminal device
33 Privacy policy storage unit
34 Service providing device
35 Network
51 Policy item analysis unit
52 Policy Item management unit
53 Policy analysis unit
54 Summary generation unit
55 Dialog recording unit
56 Dialogue history storage unit
57 Instruction analysis unit
58 Policy detail acquisition unit
59 Consent/refusal management unit
60 Consent/refusal history storage unit
71, 71-1 to 71-n Policy item group
91, 91-1 to 91-n Privacy policy
111 Control unit
112 Operation display unit
113 Voice input/output unit
131 Control unit
132 Privacy policy reading unit
133 Item analysis unit
134 Output unit
141 Natural language analysis unit
142 JSON/XML analysis unit
143 HTML analysis unit
151 Policy item group storage unit
152 Control unit
153 Output unit
171 Control unit
172 Each-item comparison unit
173 Difference information generation unit
191 Control unit
192 Summary description generation unit
193 Summary information generation unit
211 Voice summary generation unit
212 Management list summary generation unit
213 Icon summary generation unit
214 Item group full display summary generation unit
231 Control unit
232 Voice analysis unit
233 Tap analysis unit
234 Command analysis unit
235 Output unit
271 Control unit
272 Policy detail reading unit
273 Description generation unit
291 Control unit
292 Consent/refusal notification unit
293 Consent/refusal history recording unit
311, 311-1 to 311-n Communication format conversion unit
312 Standardized communication format conversion unit
331 Separation unit
332 Item weighting unit
333 Item weighting information storage unit
334 Policy document extraction unit
335 Text conversion unit
341 Reason ascertainment unit
351 Imaging unit
371 Gender estimation unit
372 Age estimation unit
373 Voiceprint extraction unit
381 Summary information generation unit
391 Emphasis summary generation unit
421 Sensor unit
422 External server
431 Consent/refusal automatic determination unit
432 Consent/refusal automatic determination condition storage unit
433 External information acquisition unit

1. An information processing apparatus comprising:
an analysis unit configured to analyze an item of a service agreement; and
a summary generation unit configured to generate a summary of a service agreement on a basis of an analysis result by the analysis unit.

2. The information processing apparatus according to claim 1, further comprising:
a service agreement item analysis unit configured to analyze an item of the service agreement, list a content for every item, and generate a service agreement item group for every the service agreement; and
a service agreement item management unit configured to store and manage the service agreement item group that is for every the service agreement and is generated by the service agreement item analysis unit.

3. The information processing apparatus according to claim 1, wherein
the analysis unit generates, as an analysis result, difference information including a common item and a difference item in a same item of a plurality of service agreements.

4. The information processing apparatus according to claim 3, wherein
the summary generation unit generates the summary for emphasis display of a difference item in the difference information on a basis of an analysis result including the difference information.

5. The information processing apparatus according to claim 3, further comprising:
a summary description generation unit configured to generate a summary description on a basis of an analysis result including the difference information, wherein
the summary generation unit processes and generates the summary description in accordance with a terminal device operated by a user to whom the summary is presented.

6. The information processing apparatus according to claim 5, wherein
in a case where the terminal device has a display unit smaller than a first area, the summary generation unit generates a summary by processing the summary description into a simple list, supplies in response to a request from the terminal device, and causes the display unit to display.

7. The information processing apparatus according to claim 6, further comprising:
a detailed information generation unit, wherein, in a case where the summary is obtained by processing the summary description into a simple list, when an item processed into the simple list is selected, the detailed information generation unit generates detailed information of the selected item, supplies in response to a request from the terminal device, and causes display.

8. The information processing apparatus according to claim 6, wherein
in a case where the terminal device has a display unit smaller than a second area that is further smaller than the first area, the summary generation unit iconifies the summary description to generate a summary.

9. The information processing apparatus according to claim 5, wherein
in a case where the terminal device has a voice output unit configured to output voice, the summary generation unit generates a summary by processing the summary description into voice data.

10. The information processing apparatus according to claim 9, wherein
the summary generation unit generates a summary by processing, into voice data, the summary description for emphasis of a difference item in the difference information by voice, on a basis of an analysis result including the difference information.

11. The information processing apparatus according to claim 6, further comprising:
a service agreement item analysis unit configured to analyze an item of the service agreement, list a content for every item, and generate a service agreement item group for every the service agreement, wherein
in a case where the terminal device has a display unit larger than a predetermined area, the summary generation unit uses information of the service agreement item group as it is, and generates a summary for emphasis display of information of the difference item.

12. The information processing apparatus according to claim 2, further comprising:
a consent/refusal management unit configured to accept and manage consent or refusal for the service agreement;
a reason ascertainment unit configured to ascertain a reason for the consent or refusal; and
a weighting unit configured to weight every item in the service agreement item group in accordance with a reason ascertained by the reason ascertainment unit, wherein
the summary generation unit adjusts emphasis display for the every item to generate a summary, in accordance with a weight weighted by the weighting unit.

13. The information processing apparatus according to claim 12, further comprising:
a consent/refusal determination unit configured to determine consent or refusal for the service agreement on a basis of a summary of the service agreement and a consent/refusal determination condition stored in advance, wherein
the consent/refusal management unit accepts and manages consent or refusal determined by the consent/refusal determination unit for the service agreement.

14. The information processing apparatus according to claim 12, wherein
the consent/refusal management unit accepts and manages consent or refusal of a user for the service agreement.

15. The information processing apparatus according to claim 14, further comprising:
a gender estimation unit configured to estimate gender on a basis of voice uttered by the user; and
an age estimation unit configured to estimate age on a basis of voice uttered by the user, wherein
the summary generation unit adjusts emphasis display for the every item to generate a summary, on a basis of a weight weighted by the weighting unit, gender estimated by the gender estimation unit, and age estimated by the age estimation unit.

16. The information processing apparatus according to claim 14, further comprising:
a text conversion unit configured to convert a service agreement that is printed or displayed, into text from an image obtained by imaging a service agreement that is printed or displayed, wherein
the analysis unit analyzes an item of the service agreement converted into text, and
the summary generation unit generates a summary for emphasis display, by overlaying and displaying on the imaged service agreement that is printed or displayed on the image for the every item, in accordance with a weight weighted by the weighting unit.

17. The information processing apparatus according to claim 14, wherein
when accepting consent or refusal of a user for the service agreement, the consent/refusal management unit preforms conversion into a format receivable by each service providing device that provides a service corresponding to the service agreement, and notifies of information about the consent or refusal.

18. The information processing apparatus according to claim 14, further comprising:
a voiceprint extraction unit configured to extract a voiceprint on a basis of voice uttered by the user, wherein
when accepting consent or refusal of a user for the service agreement, the consent/refusal management unit stores the voiceprint in a predetermined storage unit in association with information about the consent or refusal.

19. An information processing method comprising:
an analyzing process of analyzing an item of a service agreement; and
a summary generating process of generating a summary of a service agreement on a basis of an analysis result by the analyzing process.

20. A program for causing a computer to function as:
an analysis unit configured to analyze an item of a service agreement; and
a summary generation unit configured to generate a summary of a service agreement on a basis of an analysis result by the analysis unit.
